(19) United States
(12) Patent Application Publication
(10) Pub. No.: US 2003/0228123 A1
(43) Pub. Date: Dec. 11, 2003

(54) Low loss polymeric optical waveguide materials

(76) Inventors: Mark Andrews, Westmount (CA); Maria Petrucci, Saint-Sauveur (CA); Veronique Leblanc-Boily, Laval (CA); Zakaria Saddiki, Lachine (CA); Louis-Philippe Labranche, Verdun (CA); Jianping Lu, Montreal (CA); Guoyin Zhang, Nepean (CA); Christian Ouellet, Montreal (CA)

Correspondence Address: KNOBBE MARTENS OLSON & BEAR LLP, 2040 MAIN STREET, FOURTEENTH FLOOR, IRVINE, CA, 92614, US

(21) Appl. No.: 10/156,646

(22) Filed: May 24, 2002

(51) Int. Cl. G02B 6/00

(52) U.S. Cl. 385/143

(57) ABSTRACT

An organic polymeric optical waveguide and methods of making same are described herein. The waveguide can be used in an integrated optical waveguide device. The organic polymeric material contains styrenic monomers and can incorporate styrenic or epoxy crosslinking groups.

### FIELD OF THE INVENTION

The present invention relates to optical waveguides and devices that can be prepared from organic polymers.

### BACKGROUND OF THE INVENTION

Dense wavelength division multiplexing is a technique for transmitting data over an optical fiber. Dense wavelength division multiplexing involves multiplexing many different wavelength signals onto a single fiber. Parallel wavelengths can be densely packed and integrated onto a transmission system utilizing multiple, simultaneous, extremely high frequency signals in the 192 to 200 terahertz range. Systems utilizing dense wavelength division multiplexing may suffer from drawbacks, however, including cross-talk (a measure of how well channels are separated) and difficulties in maximizing channel separation (or the ability to distinguish each wavelength).

Dense wavelength division multiplexing systems with sixteen or more channels are commercially available. In order to combine or separate optical signals for dense wavelength division multiplexing, specialized devices are employed. A multiplexer (MUX) takes optical wavelengths from multiple fibers and converges them into a single light beam. A demultiplexer (DEMUX) separates out each of the wavelength components of the light beam and couples them to individual fibers. In a unidirectional system (i.e., a system using a pair of optical fibers) there is a MUX at the sending end of the fiber and a DEMUX at the receiving end of the fiber. In a bidirectional system (i.e., a system using a single optical fiber) there is a multiplexer/demultiplexer (MUX/DEMUX) at each end of the fiber.

A variety of techniques may be employed for multiplexing and demultiplexing. In prism refraction demultiplexing, the light beam impinges on a prism surface, whereby each component wavelength is refracted differently. Each component wavelength exiting the prism is focused by a lens to enter into an end of an optical fiber. By reversing the order of the lens and prism, different wavelengths from multiple fibers may be multiplexed onto a single optical fiber. In multilayer interference filters, a series of thin film filters are cascaded in the optical path. Each filter transmits one wavelength while reflecting others, thus a series of filters may be employed to separate multiple wavelengths. An arrayed waveguide grating (AWG) includes an array of curved-channel waveguides, each waveguide having a different path length. Light enters the input cavity, is diffracted, and enters the waveguide array where the different path lengths introduce phase delays for the different wavelengths in the output cavity where an array of fibers is located. The different wavelengths exhibit maximum interference at different locations corresponding to the output ports of the AWG.

The production of integrated optical elements, such as arrayed waveguide grating (AWGs) and dense wavelength division multiplexer/demultiplexers (DWDMs) is well known. For example, U.S. Pat. No. 6,069,990 to Okawa, et al. discloses one such production method.

There are many materials from which integrated optical elements can be made. In conventional AWGs, such materials include, but are not limited to, pure or doped silica glass, semiconductor compositions, and organic polymers. There are also several methods for using the aforementioned materials to make AWGs. These methods include, but are not limited to, flame hydrolysis deposition (FHD), plasma enhanced chemical vapor deposition (PE-CVD), molecular beam epitaxy (MBE), metallo-organic chemical vapor deposition (MO-CVD), and coating of organic polymers.

Each of these methods has its advantages and disadvantages. FHD has the disadvantage of high temperature processing (on the order of 1000° C. or more). It is also a time consuming process because it requires multiple processing steps, such as repeated stages of thermal annealing and consolidation (densification) of the deposited glass. In addition, FHD utilizes environmentally sensitive gases, such as chlorosilanes and phosphines, in the glass alloying process, thereby requiring corresponding safety and environmental systems. Moreover, FHD does not lend itself to the coverage of large area substrates, for example, those having a surface area of about 1000 cm² or more. Furthermore, such high temperature processes are not compatible with the manufacture of semiconductor devices such as application-specific integrated circuits (ASICs) because such semiconductor devices are destroyed by the high temperature processes of FHD.

PE-CVD can be practiced at substantially lower temperatures than can FHD, but it has the disadvantage of being a capital-intensive equipment process. PE-CVD requires almost as many steps as does FHD, and usually requires a long period of time for consolidation and densification of the deposited glass in order to be suitable for optical applications.

MBE is a technique for growing crystalline layers of one material (often a semiconductor) deposited on top of another crystalline material. The substrate (supporting) crystal layer imposes its crystal lattice structure closely, if not identically, onto the structure of the deposited material. The technique is employed to fabricate many kinds of semiconductor microelectronic and optoelectronic devices. Major drawbacks of the MBE technique include that it is compatible with a limited range of semiconductor materials, that it is capital-intensive equipment process, and that it often employs environmentally sensitive gases (e.g., phosphines and arsines).

MO-CVD converts volatile organometallic molecules into semiconductor crystalline materials by moderate to high temperature decomposition of the organometallic species on a heated substrate surface. In general, with an appropriate choice of semiconductor composition, semiconductor materials can be employed to make multiplexers and demultiplexers. For example, silicon can be employed to guide light and to make DWDM devices. The crystalline silicon is typically processed in the manner of the semiconductor devices described above.

Semiconductor materials suffer several disadvantages, however, when employed in integrated optical devices. Because semiconductors are crystalline, the optical properties of light propagating in semiconductor integrated optical devices can depend on the atomic patterning of the crystal. One of the difficulties of semiconductor DWDMs is that the semiconductor materials are birefringent as a result of the dependence on crystal structure. This birefringence is undesirable in optical information technology processing applications. In addition, semiconductor processing for DWDM manufacture is very capital equipment-intensive, making the process expensive when compared with some other methods.

Moreover, semiconductors are not generally preferred because the refractive index of the semiconductor is higher than that of the glass optical fiber with which it must be connected. Such mismatches in the refractive index give rise to Fresnel reflectance losses that degrade the performance of the device by attenuating the transmitted light. To overcome these losses, a semiconductor DWDM is usually connected to an optical amplifier to increase the intensity of the light signal going into and/or out of the DWDM. Like FHD, it is not possible with semiconductor processing to cover very large area surfaces, for example, those on the order of 1000 cm² or larger.

However, the FHD, PE-CVD, integrated optical devices, and semiconductor processes cannot incorporate organic materials directly into the integrated optical devices because the organic material is destroyed by the plasma or by the high temperature processes. Incorporation of organic materials in the integrated optical devices can impart desirable optical properties to the devices. For example, these properties include ease of altering the refractive index of the glass via the organic moiety, optical nonlinearity for fast modulation and switching, and the capability of direct photo-patternability imparted by the photosensitive response of the organic compound.

Organic polymers offer distinct advantages for making integrated optical devices, such as DWDMs. Polymers can be photo-patterned more easily, and photopatterning can be achieved in a variety of polymeric media, including, but not limited to, polyimides, polysiloxanes, polyesters, polyacrylates, and the like.

Moreover, polymers can be coated over large areas and fabricated into patterns using equipment that is less expensive than that required for FHD, PE-CVD, MO-CVD, and MBE. While not as durable as glass, organic polymers can exhibit many of the desirable features of glass, for use in integrated optics devices. Polymers are advantageous for use in integrated optical applications in that the polymers can host organic molecules exhibiting optical nonlinearity for optical modulation and switching of opto-communications and optoelectronic communications signals.

However, some polymers have the disadvantage of being generally less environmentally stable than glasses and semiconductors. Also, many polymers cannot withstand processing temperatures greater than about 100° C. because of the phenomenon of flow above the glass transition temperature (T_{g}) of the polymer. Such flow can cause the optical circuit to change its shape, which can adversely affect the performance of the integrated optical device.

### SUMMARY OF THE INVENTION

A polymeric material for use in preparing DWDMs that exhibits satisfactory thermal and optical stability, glass transition temperature, optical properties, and ease of fabrication is desirable. Organic polymer-based optical waveguides are generally satisfactory in all of these properties, as compared with waveguides prepared by the aforementioned processes of FHD, PE-CVD, MBE and MO-CVD, especially in regards to process capability and cost.

In a first embodiment, a polymeric material is provided, the material including a glycidyl methacrylate monomer; a 2,3,4,5,6-pentafluorostyrene monomer; and a styrene monomer.

In aspects of the first embodiment, the weight ratio of glycidyl methacrylate monomer to 2,3,4,5,6-pentafluorostyrene monomer to styrene monomer is about 5 to about 30:about 30 to about 90:about 5 to about 40; or about 10 to about 25:about 40 to about 80:about 10 to about 35; or about 15 to about 20:about 50 to about 70:about 15 to about 30.

In a second embodiment, an optical device is provided, the device including a polymeric material formed from a glycidyl methacrylate monomer; a 2,3,4,5,6-pentafluorostyrene monomer; and a styrene monomer.

In an aspect of the second embodiment, the optical device is an integrated optical waveguide device, such as a dense wavelength division multiplexing device.

In an aspect of the second embodiment, the optical device includes a substrate, a buffer layer, a guide layer, and a cladding layer.

In an aspect of the second embodiment, the buffer layer includes the polymeric material formed from glycidyl methacrylate monomer; 2,3,4,5,6-pentafluorostyrene monomer; and styrene monomer.

In a third embodiment, a process is provided for preparing a polymeric material for use in fabricating an optical device, the process including the steps of providing a first monomer including glycidyl methacrylate; providing a second monomer including styrene; providing a third monomer including 2,3,4,5,6-pentafluorostyrene; providing a polymerization catalyst; and polymerizing the monomers, whereby a terpolymeric material suitable for use in fabricating an optical device is obtained.

In an aspect of the third embodiment, the polymerization catalyst includes benzoyl peroxide.

In a fourth embodiment, a polymeric material is provided, the material including a styrene monomer, a 2,3,4,5,6-pentafluorostyrene monomer, and a 2,3,5,6-pentafluoro-4-oxystyrene-styrene monomer.

In aspects of the fourth embodiment, the weight ratio of styrene monomer to 2,3,4,5,6-pentafluorostyrene monomer to 2,3,5,6-pentafluoro-4-oxystyrene-styrene monomer is about 5 to about 30:about 30 to about 90:about 10 to about 35; or about 10 to about 25:about 50 to about 80:about 10 to about 30; or about 15 to about 25:about 55 to about 70:about 15 to about 25; or about 5 to about 30:about 40 to about 90:about 5 to about 25; or about 10 to about 25:about 50 to about 80: about 8 to about 20; or about 15 to about 25: about 55 to about 70: about 10 to about 15; or about 0.2: about 0.6: about 0.2.

In a fifth embodiment, an optical device is provided including a polymeric material formed from a styrene monomer, a 2,3,4,5,6-pentafluorostyrene monomer, and a 2,3,5,6-pentafluoro-4-oxystyrene-styrene monomer.

In an aspect of the fifth embodiment, the optical device is an integrated optical waveguide device, such as a dense wavelength division multiplexing device.

In an aspect of the fifth embodiment, the optical device includes a substrate, a buffer layer, a guide layer, and a cladding layer.

In an aspect of the fifth embodiment, the guiding layer includes the polymeric material formed from the styrene monomer, the 2,3,4,5,6-pentafluorostyrene monomer, and the 2,3,5,6-pentafluoro-4-oxystyrene-styrene monomer.

In an aspect of the fifth embodiment, the cladding layer includes the polymeric material formed from the styrene monomer, the 2,3,4,5,6-pentafluorostyrene monomer, and the 2,3,5,6-pentafluoro-4-oxystyrene-styrene monomer.

In a sixth embodiment, a process is provided for preparing a polymeric material for use in fabricating an optical device, the process including the steps of providing a first monomer including 2,3,4,5,6-pentafluorostyrene; providing a second monomer including styrene; providing a polymerization catalyst; polymerizing the first and second monomers, whereby a copolymeric material is formed, the copolymeric material including a plurality of fluorine substituents; reacting the copolymeric material with 4-hydroxystyrene in the presence of a base such that a portion of the fluorine substituents are replaced by vinyl phenyl ether substituents, whereby a material suitable for use in fabricating an optical device is obtained.

In an aspect of the sixth embodiment, the polymerization catalyst includes benzoyl peroxide.

In a seventh embodiment, a polymeric material is provided, the material including a terpolymer of Formula I:

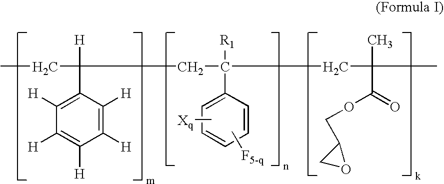

wherein q is an integer from 0 to 5; p is an integer from 0 to 10; y is an integer from 0 to 4; R₁ is —CH₃ or H; X is independently selected from Cl, Br, —CF3, —(CF2)p—CF3,

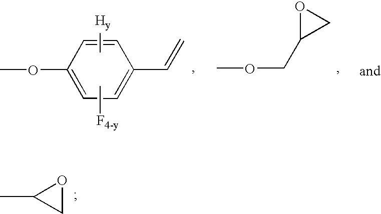

and m, n, and k are non-zero integers.

In aspects of the seventh embodiment, the ratio of m:n:k is about 5 to about 30:about 30 to about 90:about 5 to about 40; or about 10 to about 25:about 40 to about 80:about 10 to about 35; or about 15 to about 20:about 50 to about 70:about 15 to about 30; or about 7:about 2:about 1.

In an aspect of the seventh embodiment, X is —C(CF₃)₂H.

In an aspect of the seventh embodiment, X is —(CF₂)ₚ—CF₃ and p is 8.

In an aspect of the seventh embodiment, X is —(CF₂)ₚ—CF₃ and p is 10.

In an aspect of the seventh embodiment, X is

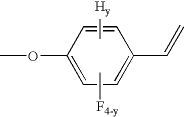

and q is 0.

In an aspect of the seventh embodiment, the terpolymer is a block polymer.

In an aspect of the seventh embodiment, the terpolymer is a random polymer.

In an aspect of the seventh embodiment, the polymeric material includes an optical device, such as an integrated optical waveguide device.

In an eighth embodiment, a process is provided for preparing a polymeric material for use in fabricating an optical device, the process including the steps of providing a first monomer including glycidyl methacrylate; providing a second monomer of Formula IA:

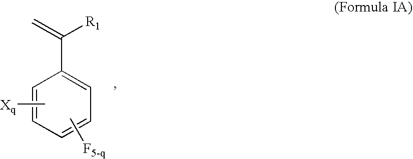

wherein X is independently selected from Cl, Br, —CF3, —(CF2)p—CF3,

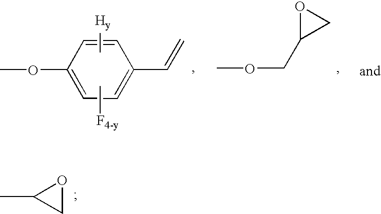

R₁ is —CH₃ or H; q is an integer from 0 to 5, p is an integer from 0 to 10, and y is an integer from 0 to 4; providing a third monomer of Formula IB:

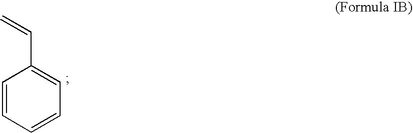

providing a polymerization catalyst; and polymerizing the monomers, whereby a polymeric material suitable for use in fabricating an optical device is obtained.

In a ninth embodiment, a polymeric material is provided, the material including a terpolymer of Formula II:

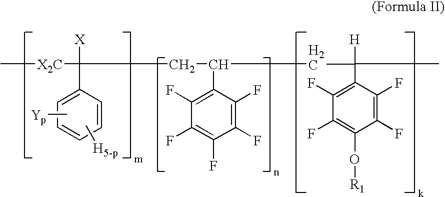

wherein X is independently selected from H, D, and F; Y is independently selected from F and D; R₁ is

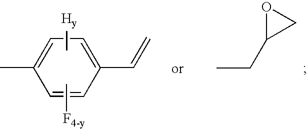

y is an integer from 0 to 4; p is an integer from 0 to 5; and m, n, and k are non-zero integers.

In aspects of the ninth embodiment, the ratio of m:n:k is about 5 to about 30:about 40 to about 90:about 5 to about 25; or about 10 to about 25:about 50 to about 80:about 8 to about 20; or about 15 to about 25:about 55 to about 70:about 10 to about 15; or about 5 to about 30:about 40 to about 90:about 10 to about 35; or about 10 to about 25:about 50 to about 80:about 10 to about 30; or about 15 to about 25:about 55 to about 70:about 15 to about 25; or about 0.2:about 0.6:about 0.2.

In an aspect of the ninth embodiment, R₁ is

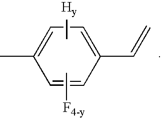

In an aspect of the ninth embodiment, R₁ is

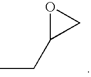

In an aspect of the ninth embodiment, X is F.

In an aspect of the ninth embodiment, the terpolymer is a block polymer or a random polymer.

In an aspect of the ninth embodiment, the polymeric material includes an optical device, such as an integrated optical waveguide device.

In a tenth embodiment, a process is provided for preparing a polymeric material for use in fabricating an optical device, the process including the steps of providing a first monomer including 2,3,4,5,6-pentafluorostyrene; providing a second monomer of Formula IIB:

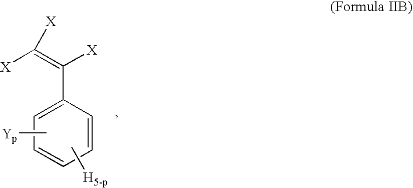

wherein p is an integer from 0 to 5, Y is independently selected from F and D, and X is independently selected from H, D, and F; providing a polymerization catalyst; polymerizing the first monomer and the second monomer, whereby a copolymeric material is obtained, the copolymeric material including a plurality of fluorine moieties, the fluorine moieties including substituents on a benzene ring; and reacting, under alkaline conditions, the copolymeric material with a hydroxy compound of formula:

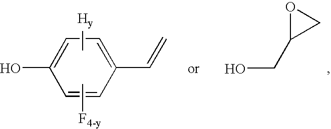

wherein y is an integer from 0 to 4, such that a portion of the fluorine moieties are replaced by an oxy moiety derived from the hydroxy compound, whereby a polymeric material suitable for use in fabricating an optical device is obtained.

In an eleventh embodiment, a polymeric material is provided, the material including a terpolymer of Formula III:

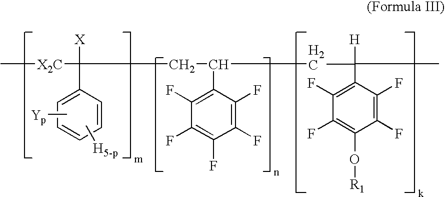

wherein X is independently selected from H, D, and F; Y is independently selected from F and D; R₁ is

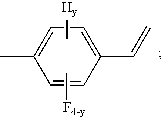

y is an integer from 0to 4; p is an integer from 0to 5; and m, n, and k are non-zero integers.

### BRIEF DESCRIPTION OF THE DRAWINGS

FIG. 1 shows layers of an embodiment of a device comprising a silicon wafer, a buffer layer, a guiding layer, and a cladding layer; and the refractive indices of the layers.

FIG. 2 shows a flow chart of a microfabrication process.

FIG. 3 shows FTIR spectra for the base copolymer prepared in Example 1 and the guiding polymer prepared in Example 3.

FIG. 4 shows a FTIR spectrum for the cladding polymer prepared in Example 4.

FIG. 5 shows a FTIR spectrum for the buffer polymer prepared in Example 5.

FIG. 6 shows FTIR spectra for homopolymers of ST, FEMA, and GMA.

### DETAILED DESCRIPTION OF THE PREFERRED EMBODIMENT

The following description and examples illustrate embodiments compatible with the present invention. Those of skill in the art will recognize that there are numerous variations and modifications of the embodiments that are also compatible with the present invention. Accordingly, the description of the embodiments herein should not be deemed to limit the scope of the present invention.

In preferred embodiments, an optical waveguide is provided which incorporates organic polymers. The polymers include, but are not limited to, polymeric materials including styrenic or epoxy moieties as crosslinking groups. The polymeric materials are both photocrosslinkable and thermocrosslinkable, and exhibit low loss and very low birefringence. Optical waveguides prepared from such polymers can be employed in integrated optical waveguide devices comprising AWGs, couplers, wavelength division multiplexers (WDMs), such as dense wavelength division multiplexer (DWDM), coarse wavelength division multiplexer (CWDM), and optical devices comprising combinations of these elements.

The performance of an integrated optical waveguide device may be affected by any number of factors, including various linear and nonlinear effects. In Polarization Mode Dispersion (PMD), components of a signal having different polarizations travel at different speeds within an optical fiber or other optical device, resulting in multipath interference when the signal reaches the receiver. PMD becomes more of a problem the longer the distance traveled by the signal, and generally only becomes a problem in long haul systems (i.e., systems wherein the signal travels for more than 500 km).

Other effects include wavelength or chromatic dispersion, wherein optical pulses spread out as they travel over an optical fiber, eventually causing the pulses to overlap, and thereby limiting the rate at which signals may be transmitted over the fiber. Waveguide dispersion occurs because the refractive index difference between the cladding or buffer layer and the guiding layer varies with wavelength. Light of short wavelengths tends to be confined within the guiding layer, such that the effective refractive index is close to the actual refractive index of the guiding material. Light of longer wavelengths spreads into the cladding, however, which results in an effective refractive index close to the actual refractive index of the cladding. Waveguide dispersion may result in propagation delays of certain wavelength components of a signal.

In addition, other nonlinear effects can contribute to signal attenuation. Stimulated Brillouin scattering is caused by back reflection of light due to acoustic waves generated by the interaction of the transmitted light with silica molecules in the optical fiber. Stimulated Brillouin scattering can occur in systems wherein high laser output powers are employed. Rayleigh scattering is the most common form of scattering and results from scattering from variations of the refractive index due to variations in the density of the fiber or optical component. Stimulated Raman scattering results in wavelength shifts of the scattered light as a result of interactions with the silica molecules in a fiber or component. Signal attenuation can result from such scattering, as well as from adsorption processes and stresses on the fiber.

In four-wave mixing, nonlinear interactions among the different channels due to the nonlinear nature of the refractive index of the guiding material create sidebands that result in inter-channel interference. For example, two or more signals of different frequencies can interact, resulting in the formation of an additional frequency, causing cross-talk and a decrease in the signal-to-noise ratio. Impurities or atomic level defects can absorb energy. Absorptive effects generally tend to have a greater effect on longer wavelengths of light (e.g., >1,700 nm) whereas scattering processes tend to have a greater effect on shorter wavelengths (e.g., <800 nm). Fresnel reflections result from discontinuities in the fiber optic system (e.g., splices in a fiber, air gaps, or interfaces between components). Differences in the refractive index at such interfaces result in back reflection of light and associated signal attenuation.

It is therefore preferred to employ materials in fiber optic systems that reduce the signal attenuation due to scattering. Materials of the preferred embodiments can contain fluorine or deuterium atoms. Such materials exhibit low loss in optical power (typically measured in dB), namely, low signal attenuation and low back-reflection of the signal.

Waveguide Structure

Optical waveguides can include a substrate, a buffer layer, a cladding layer, and a guide. As described below, the organic polymers in accordance with embodiments of the present invention may be useful in preparing one or more of these components of the optical waveguide.

Substrate

Optical waveguides are typically fabricated on a substrate comprising a silicon wafer. However, any suitable material may be employed as the substrate. Other suitable substrates include, but are not limited to, silica, glass, polymeric materials, semiconductors, single crystal silicon wafers, borosilicate glasses, polycarbonate, chlorotrifluoroethylene (CTFE), polyetherimide (e.g., the polyetherimide marketed under the tradename ULTEM® 1000 by GE Plastics of Pittsfield, Mass.), MgF₂, CaF₂, crystal quartz, germanium, GaAs, GaP, ZnSe, ZnS, Cu, Al, Al₂O₃, NaCl, KCl, KBr, LiF, BaF₂, thallium bromide (commonly referred to as “KRS-5”), and thallium bromide chloride (commonly referred to as “KRS-6”).

Antireflective Coating

In preferred embodiments, the substrate is optionally provided with an antireflective coating. Although any suitable antireflective coating may be used, in one embodiment, the anti-reflective coating is preferably a commercially available coating marketed as XHRiC-16 by the ARC® Division of Brewer Science, Inc., of Rolla, Mo. The coating includes about 70-90% 1-methoxy-2-propanol, about 7-10% ethyl lactate, and small amounts of modified Novolak resin and aminoplast resin. The coating exhibits an n-value of 1.84 and a k-value of 0.34, giving excellent absorbance. In other embodiments, however, other anti-reflective coatings may be preferred.

Cladding Layer

The cladding layer is a transparent layer that covers the guiding layer. The cladding layer has a lower refractive index than the guiding layer, so that when light traveling within the guiding layer strikes the boundary between the cladding and the guiding layer at an angle above the critical angle, φ_{c}, the light undergoes total internal reflection, thereby remaining in the guiding layer. The critical angle is defined as follows:

φ_{c}=arcsin(nᵣ/nᵢ)

wherein nᵣ is the refractive index of the cladding layer and nᵢ is the refractive index of the guiding layer. The difference in the refractive index of the cladding layer and the guiding layer need not be large. For example, a difference of 1% in the refractive indices will yield a value for φ_{c} of 82°.

In certain embodiments, the cladding layer can include the organic polymers described below. Other embodiments utilize other materials as are known in the art for the cladding layer. While certain conventional cladding materials that require high temperature processing steps may not be preferred for use, if the issues relating to processing temperature may be overcome, then there is no obstacle to the use of such materials.

Buffer Layer

The buffer layer isolates the optical field in the guiding layer from the substrate. As does the cladding layer, the buffer layer has a lower refractive index than does the guiding layer. In certain embodiments, the buffer layer can include the organic polymers described below. Other embodiments utilize other materials as are known in the art for the buffer layer. Other materials include, but are not limited to, semiconductors, such as gallium arsenides and indium phosphides; ceramic materials, such as ferroelectric materials and lithium niobate; plastics; and composite materials, such as circuit boards and plastic components. While certain conventional buffer layer materials which require high temperature processing steps may not be preferred for use, if the issues relating to processing temperature may be overcome, then there is no obstacle to the use of such materials.

Guide

Light signals travel primarily within the guiding material. The guiding layer has a refractive index greater than that of the buffer layer and cladding layer surrounding it. In certain embodiments, the guiding layer can include the organic polymers described below. Other embodiments utilize other materials as are known in the art for the guiding layer. Other materials include, but are not limited to, semiconductors, silica, silicon, and transparent ceramics. While certain conventional guiding materials that require high temperature processing steps may not be preferred for use, if the issues relating to processing temperature may be overcome, then there is no obstacle to the use of such materials.

Waveguide Device

A typical optical device generally comprises at least three layers: a buffer layer, a guiding layer, and a cladding layer, each of which may comprise a polymer. For each layer, a polymer is synthesized which meets certain criteria, such as, but not limited to, low loss, specific refractive index on slab, chemical stability, thermal stability, photosensitivity, and the like. To make a polymer film that forms a layer in an optical device, the polymer is typically dissolved in a solvent or co-solvents system, then filtered through a 0.2 μm filter and finally spin-coated on a 6-inch diameter silicon wafer. While this method is generally preferred for most applications due to its simplicity, other polymer deposition methods or substrates, as are known in the art, may be preferred for preparing certain films or layers.

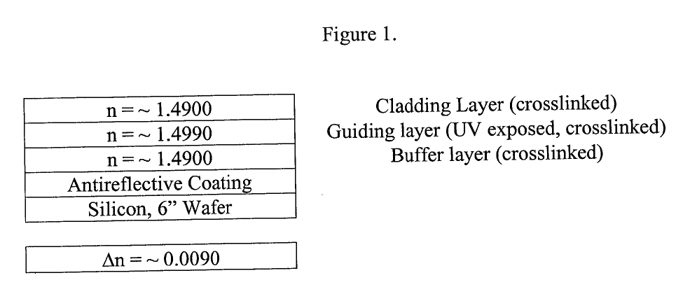

Each layer of the device has a specific Refractive Index (n) so as to achieve a specified value for Δn. For example, Δn=0.01 (Δn=((n_{guiding})−(n_{buffer}))=((n_{guiding})−(n_{cladding})) as shown in FIG. 1. In various embodiments, other values for Δn may be preferred. Typical preferred values for Δn are from about 0.007 or lower to about 0.013 or higher, and more preferably about 0.010.

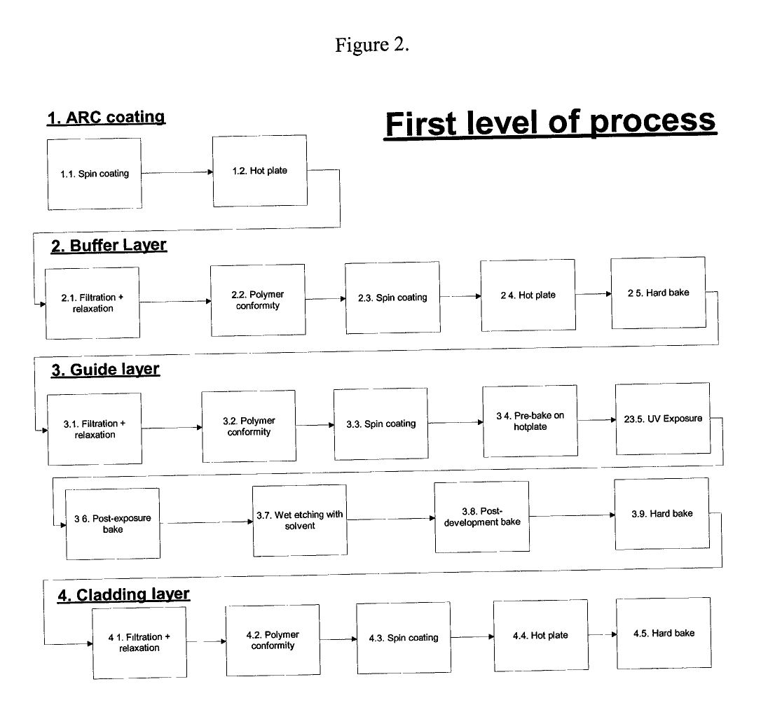

A microfabrication process suitable for use in preferred embodiments of the process is described in FIG. 2. In such a process, as a first step it is generally preferred to apply an anti-reflective coating directly to the wafer. A buffer layer solution is then prepared, then spin-coated onto a substrate. The substrate is set on a hotplate and the buffer layer is subsequently hard-baked. Next, a guiding layer solution is prepared. The guiding layer solution is spin-coated onto the substrate over the buffer layer. Then, the guiding layer is pre-baked on a hotplate. The guiding layer is subsequently exposed to UV radiation and then goes through a post-exposure bake. Then, the guiding layer is wet-etched. Subsequently, there is a post-development bake and then a hard-bake. Finally, a cladding layer solution is prepared. The cladding layer solution is spin-coated. Then, the material is set on a hotplate and hard-baked. After this process, the wafer is diced to create individual chips.

A waveguide is typically cross-linked using a photolithographic technique (for example, UV exposure in presence of a photoinitiator and a photosensitizer) on a guiding layer. Different photomask designs may be employed to create a desired pattern in the layer. A post-exposure-bake is typically conducted to activate polymer densification. Then, a wet etching with a solvent is performed to remove the portion of the guiding layer that was not cross-linked. Suitable wet-etching solvents may include, but are not limited to, acetone, ketone, alcohol, halogenated organic solvents, such as chloroform or methylene chloride, or aromatic solvents, such as toluene. The preferred wet etchant may vary depending upon the material to be etched. Other techniques may also be employed to remove the part of the guiding layer (e.g., laser ablation or reactive ion etching). A cladding layer can be tailored to reduce the stress induced polarization dependent loss (PDL) on the waveguides.

Polymeric Materials

As mentioned above, in preferred embodiments, an optical waveguide is provided which incorporates organic polymers. The polymers include, but are not limited to, polymers incorporating a styrenic or epoxy moiety as a cross-linking group. In certain embodiments, base monomers that may be employed to prepare the polymers of preferred embodiments can include moieties such as, for example, fluoro- and/or deutero-substituted carbon atoms, fluoroacrylates, fluoroaryl acrylates, fluorinated alkenyls, chloro- and/or deutero-substituted carbon atoms, chlorinated acrylates, chlorinated aryl acrylates, chlorinated alkenyls, and combinations thereof.

In certain embodiments, it may be preferred that one or more of the base monomers include one or more of the same or different substituents. Preferred substituents include alkyl chains, typically containing from about 2 to about 10 or more carbon atoms. While alkyl groups are generally preferred as substituents, in certain embodiments other hydrocarbon substituents may also be suitable, including, but not limited to, aryl, alkenyl, cycloalkyl, cycloalkenyl, bicyclic or multicyclic hydrocarbon groups, branched chains, straight chains, combinations of any of the foregoing, and the like. The hydrocarbon groups may be substituted or unsubstituted, for example, by one or more heteroatoms. Suitable hydrocarbon groups may include a range of carbon atoms, for example, 1, 2, 3, 4, 5, 6, 7, 8, 9, 10, or more carbon atoms. Examples of such hydrocarbon groups include, but are not limited to, propyl, isopropyl, n-butyl, tert-butyl, pentyl, hexyl, heptyl, and higher. In certain embodiments, it may be preferred to substitute one or more hydrogen atoms on the hydrocarbon group with a deuterium atom.

Deuterium atom or heteroatom-containing substituents may also be present, for example, those containing any halogen (including, but not limited to, fluorine, chlorine, bromine, and iodine), oxygen, sulfur, and others. The substituents are preferably situated on the epoxy, styrene, or other arene moieties. The ratio or ratios of the different monomers in the polymeric materials of preferred embodiments can vary depending upon the properties desired in the polymer. However, any one monomer typically comprises, at a minimum, of from about 3, 4, or 5 mol. % or less to about 90, 91, 92, 93, 94, or 95 mol. % or more of the polymer, preferably about 6, 7, 8, 9, or 10 mol. % to about 75, 80, or 85 mol. % of the polymer, more preferably from about 11, 12, 13, 14, 15, 16, 17, 18, 19, 20, 21, 22, 23, 24, or 25 mol. % to about 30, 35, 40, 45, 50, 55, 60, 65, or 70 mol. % of the polymer. The polymers typically possess a T_{g} in the range of about 30° C. or less to 135° C. or higher, preferably from about 35 or 40° C. to about 120, 121, 122, 123, 124, 125, 126, 127, 128, 129, 130, 131, 132, 133, or 134° C., and more preferably from about 40, 41, 42, 43, 44, 45, 46, 47, 48, 49, 50, 51, 52, 53, 54, 55, 56, 57, 58, or 59° C. to about 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, or 119° C. The preferred molecular weight for the polymer may vary depending upon the processing conditions or device to be fabricated. The molecular weight typically ranges from about 1K or less to about 200K or more, preferably from about 2, 3, 4, 5, 6, 7, 8, 9, or 10K to about 65, 70, 75, 80, 85, 90, 95, 100, 105, 110, 120, 130, 140, 150, 160, 170, 180, or 190K, morepreferably from about 11, 12, 13, 14, 15, 16, 17, 18, 19, 20, 21, 22, 23, 24, 25, 26, 27, 28, or 29K to about 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60K. In preferred embodiments, the monomers may not completely react to form a polymer. The amount of unreacted monomers can be up to about 30, 40, 50, or 60 wt. % or more of the total monomers present, preferably less than 25%, and more preferably about 0, 1, 2, 3, 4, 5, 6, 7, 8, 9, 10, or 20 wt. %.

In certain embodiments, a base polymer, e.g., a copolymer of styrene and 2,3,4,5,6-pentafluorostyrene, is finctionalized to provide the crosslinking group. In the functionalization reaction, a fluorine atom on the 2,3,4,5,6-pentafluorostyrene moiety is replaced by, e.g., a styrene or epoxy moiety. The percentage of 2,3,4,5,6-pentafluorostyrene moieties wherein a fluorine atom is replaced by a moiety capable of crosslinking can be up to about 40, 50, 60, 70, 80, 90, or 100%, preferably up to about 30%, and more preferably about 10, 15, 20, or 25%. The more crosslinking that is desired, the higher the preferred degree of substitution. Although it is generally preferred that all crosslinking substituents be identical, in certain embodiments it may be preferred to functionalize with two or more crosslinking groups, which may include the same or different crosslinking moieties, e.g, two or more different styrenic groups, or a mixture of two or more styrenic groups and epoxy groups. Typically only one fluorine atom on a pentafluorostyrene moiety is replaced. However, in certain embodiments, multiple fluorine atoms may be replaced. The fluorine atom that is replaced is preferably the one in the 4 position (para position) on the pentafluorostyrene ring. However, in certain embodiments, fluorine atoms in other positoins may be replaced.

The monomers of the polymer may be arranged in any order, including, but not limited to, arrangements characteristic of block polymers and random polymers.

Polymerization Reaction

Suitable solvents for the polymers of preferred embodiments may include any solvent that is capable of dissolving or dispersing the polymer. The solvent can have a boiling point over about 100, 110, 120, 130, 150, 200, or 250° C. or higher. However, solvents having boiling points of about 100° C. or lower may also be suitable for use in certain embodiments. Examples of preferred solvents include, but are not limited to, acetates, toluene, xylenes, benzenes, and ketones such as acetone. Preferably, the solvent is a reagent grade solvent.

Catalysts suitable for use in polymerization reactions of certain embodiments include suitable free radical initiators, for example, peroxides such as benzoyl peroxide (BPO) or acetyl peroxide, or 2′ azobisisobutyronitrile (AIBN). Ultraviolet radiation or other forms of radiation, such as thermal, IR, visible, e-beam, x-ray, and the like, can be employed in the polymerization or crosslinking reactions as well. If ultraviolet radiation is employed in the reaction, the wavelength of the ultraviolet radiation can be about 200 nm or lower to 400 nm or higher; preferably about 200, 210, 220, 230, 240, 250, 260, 270, 280, 290, 300, 310, 320, 330, 340, 390, or 400 nm; more preferably about 350, 351, 352, 353, 354, 355, 356, 357, 358, 359, 360, 361, 362, 363, 364, 365, 366, 367, 368, 369, 370, 371, 372, 373, 374, 375, 376, 377, 378, 379, or 380 nm.

Preferably, polymerization reactions are conducted under an inert atmosphere, such as a nitrogen or argon atmosphere. Preferably, ambient light in the room in which the reactions occur is UV-filtered. Clean room conditions can be employed for the reactions. Preferably, the clean room is class 100 or class 10000. However, in certain embodiments, it may be preferred to conduct the polymerization reaction under ambient conditions.

The temperature at which the polymerization reaction is conducted may depend upon the identity of the initiator employed in the reaction, or other factors. In a preferred embodiment, the initiator is benzoyl peroxide. For embodiments that employ benzoyl peroxide as the initiator, the preferred reaction temperature is about 60° C. or lower to 80° C. or higher, more preferably about 60, 61, 62, 63, 64, 65, 66, 67, 68, 69, 70, 71, 72, 73, 74, 75, 76, 77, 78, 79, or 80° C. Any suitable initiator or catalyst may be employed in the polymerization reaction, and the reaction may be conducted at any suitable temperature.

Fabrication Conditions

The fabrication methods using an organic polymer of a preferred embodiment can include, for example, methods of extrusion, deposition, spin coating, spray coating, and dip coating. The patterning of an organic film can include, for example, methods of wet etching, laser ablation, and reactive ion etching.

For microfabrication, any solvent or co-solvent mixture that has a vapor pressure acceptable for the selected method of fabrication can be employed. Preferably, the vapor pressure is less than about 40, 50, or 60 mm Hg at 25° C., more preferably about 0, 5, 10, 15, 20, 25, 30, 35, or 40 mm Hg at 25° C. The boiling point of a solvent suitable for use in microfabrication methods typically varies from about 50° C. or less to 250° C. or more; preferably from about 100 to 180° C.; more preferably from about 130-150° C.; even more preferably about 130, 132, 134, 136, 138, 140, 142, 144, 146, 148, or 150° C.

Microfabrication conditions and crosslinking catalysts can include, but are not limited to, photoinitiators, such as iodonium borate salt (available as RHORDOSIL PHOTO INITIATOR® 2074, CAS Reg. No. 178233-72-2, from Rhodia, Inc. of Rock Hill, S.C., referred to herein as “RH 2074” or “RH”), triarylsulfonium hexafluoroantimonate salts (available as Catalog #407224 from Sigma-Aldrich Canada Ltd., of Oakville, Ontario as a 50% mixture in propylene carbonate, referred to herein as “CD1010”), or [4-[(2-hydroxytetradecyl)oxy]phenyl]phenyliodonium hexafluoroantimonate (CAS Reg. No. 139301-16-9, available as Catalog #445835 from Aldrich Chemical Co., Inc., of Milwaukee, Wis., referred to herein as “CD1012”), combined with a photosensitizer, such as 2-chlorothioxanthen-9-one (CAS Reg. No. 86-39-5, available from Sigma-Aldrich Canada Ltd., referred to herein as “CTX”). The photoinitiator concentration in the solution is typically from about 0.1 wt. % or less to 10 wt. % or more, preferably from about 0.5 wt. % to about 6, 7, 8, or 9 wt. %, more preferably from about 1, 1.5, 2, 2.5, or 3 wt. % to about 5 wt. %, and most preferably from about 3, 3.2, 3.4, 3.6, or 3.8 wt. % to about 4.0, 4.2, 4.4, 4.6, or 4.8 wt. %. A single photoinitiator or a mixture of two or more photoinitiators may be employed. The photosensitizer concentration is typically from about 0.1 wt. % or less to 3 wt. % or more, preferably from about 0.2, 0.3, 0.4, or 0.5 wt. % to 1.7, 1.8, 1.9, 2.0, 2.1, 2.2, 2.3, 2.4, 2.5, 2.6, 2.7, or 2.8 wt. %, more preferably from about 0.6 wt. % to about 1.3, 1.4, 1.5, or 1.6 wt. %, and most preferably from about 0.7 wt. % to about 0.8, 0.9, 1.0, 1.1, or 1.2 wt. %. A single photosensitizer or a mixture of two or more photosensitizers may be employed. In many embodiments, a photoinitiator is present in combination with a photosensitizer. However, in certain embodiments, the photoinitiator or photoinitiators may be present without a photosensitizer.

DBU is preferably employed for crosslinking a polymer containing an epoxy moiety as the crosslinking group. The amount of DBU, based on polymer epoxy group composition, is typically from about 1 to 15 wt. %, preferably from about 2 to 8, 9, 10, 11, 12, 13, or 14 wt. %, more preferably from about 3 to 5, 6, or 7 wt. %, even more preferably about 3 wt. % to about 4 or 5 wt. %. In certain embodiments, ethylene diamine (EDA) or benzoyl peroxide (BPO) can be substituted for DBU. BPO is particularly preferred when the rcrosslinking group is a styrenic moiety.

In certain embodiments, however, it may be preferable to employ other catalysts, or even no catalyst at all, as will be appreciated by one skilled in the art. When styrene is the crosslinking group, it may be crosslinked by either radical or cationic polymerization methods as are known in the art.

Preferred temperatures for the hard bake of the buffer layer, the pre-bake, post-development bake, or hard bake of the guiding layer, or hard bake of the cladding layer may vary depending upon the polymer forming the layer. However, temperatures in the range of about 40° C. or less to about 400° C. or more, preferably from about 50° C. to about 220° C., and most preferably from about 60° C. to about 190, 195, or 200° C. are preferred for the polymers of preferred embodiments. In certain embodiments, higher or lower temperatures may be preferred.

The time required for completion of the hard-bake of the buffer layer is typically from about 30 min. or less to about 1440 min. or more, preferably from about 60 min. to about 300 min., and most preferably from about 60 min. to about 120 min.

The time required for the pre-bake of the guiding layer is typically from about 10 sec. or less to about 300 sec. or more, preferably from about 20 sec. to about 120 sec., and most preferably from about 30 sec. to about 60 sec.

The time required for the post-development bake of the guiding layer is typically from about 10 sec. or less to about 300 sec. or more, preferably from about 20 sec. to about 120 sec., and most preferably from about 30 sec. to about 60 sec.

The time required for the hard bake of the guiding layer is typically from about 30 min. or less to about 1440 min. or more, preferably from about 60 min. to about 30 min., and most preferably from about 60 min. to about 120 min.

The time required for the hard bake of the cladding layer is typically from about 30 min. or less to about 1440 min. or more, preferably from about 30 min. to about 480 min., preferably from about 60 min. to about 300 min., and most preferably from about 60 min. to about 120 min.

While the above times for the hard-bake of the buffer layer, the pre-bake of the guiding layer, the post-development of the guiding layer, the hard bake of the guiding layer, the hard bake of the cladding layer, and the hard-bake of the buffer layer are generally preferred, longer or shorter times may be preferred for certain embodiments, depending upon the polymer or other factors.

The wet etch of the guiding layer may be conducted using any suitable etchant, as are known in the art. Particularly preferred etchants include aromatic hydrocarbons, such as toluene and the xylenes, ketones such as acetone, cyclopentanone, esters, and acetates, such as propyl acetate and butyl acetate.

Curing of the guiding layer by exposure to UV radiation is typically conducted according to established curing methods. However, it is generally preferred to employ UV radiation having a wavelength of from about 300 nm to about 450 nm, more preferably from about 300 nm to about 400 nm, and most preferably from about 330 nm to about 370 nm. Any suitable dose may be employed, typically from about 170 mJ/cm² or less to about 3060 mJ/cm² or more, preferably from about 200, 225, 250, 275, 300, 325, 350, 375, 400, 425, 450, or 475 mJ/cm² to about 1050, 1100, 1150, 1200, 1250, 1500, 1750, 2000, 2250, 2500, 2750, or 3000 mJ/cm², and more preferably from about 500, 525, 550, 575, 600, 625, 650, 675, 700, 725, 750, 775, 800, or 850 mJ/cm² to about 880, 900, 920, 940, 960, 980, 1000, 1020, or 1040 mJ/cm². The preferred dose may vary depending upon the wavelength of the UV radiation and the polymer to be cured. It is also generally preferred that the UV radiation have a narrow wavelength distribution, typically from about 300 nm to about 450 nm, preferably from about 350 nm to about 370 nm, and most preferably about 365 nm.

To perform crosslinking, ultraviolet radiation is typically employed. Preferably, the ultraviolet radiation has a wavelength from about 200 or lower to 400 nm or higher; more preferably from about 225 or 250 nm to about 380 nm; even more preferably from about 275 nm to about 300, 305, 310, 315, 320, 325, 330, 335, 340, 345, 350, 355, 360, 365, 370, 375, or 380 nm.

Preferably, microfabrication processes are performed under an inert atmosphere, such as a nitrogen or argon atmosphere. Preferably, the ambient light in the room in which the reaction occurs is UV-filtered. Clean room conditions can be employed for the processes. Preferably, the clean room is class 100 or class 10000. However, in certain embodiments, it may be preferred to conduct the microfabrication process under ambient conditions.

Industry Standard for Device

For a WDM device, specifications of concern include, but are not limited to, insertion loss and uniformity between chaimels. Insertion loss of a device fabricated from the polymers of preferred embodiments is preferably below about 0.2 dB/cm for a 1550 nm wavelength signal and below about 0.1 dB/cm for a 1310 nm wavelength signal. However, in certain embodiments a higher insertion loss may be acceptable. Polarization dependent wavelength shift, which is related to birefringence of a material, is preferably less than about 0.0006, more preferably less than about 0.0004, and most preferably 0.0003, 0.0002, or less. However, in certain embodiments a higher polarization dependent loss may be acceptable. Lower molecular weight of the material comprising the optical device may yield a lower birefringence. Typically, the refractive index of the guiding layer is higher than that of the buffer, and is also higher than the refractive index of the cladding. Adhesion of the waveguide to a substrate or other interface and a resistance to delamination is also preferred.

Polymeric Materials with Styrenic Crosslinking Group

In certain preferred embodiments, the polymeric materials that form optical devices are selected from a class of polymeric materials including the styrene moiety as a crosslinking group. When compared to materials employing an epoxy group as a crosslinking group, the styrenic materials displayed reduced material loss and superior stability. Additionally, styrene can be polymerized by both radical and cationic polymerization methods. The materials can be cured by thermal or UV radiation, and are suitable for use in both wet and dry etching processes. The materials also exhibit greater moisture resistance than materials containing epoxy groups. The materials exhibit low optical absorption loss in the telecommunuications window of 1.31 to 1.55 μm (approximately 0.2-0.3 dB/cm or less), low birefringence (e.g., approximately 0.0002 or less), and low polarization dependent loss when compared to conventional materials that employ epoxy cross-linking groups. The materials are particularly well suited for use in the fabrication of 40 channel DWDM's and Variable Optical Attenuators (VOA's).

Type #1 Polymers

In a preferred embodiment, the polymeric materials include copolymers of styrene (optionally deuterated and/or fluorinated) and 2,3,4,5,6-pentafluorostyrene, wherein a number of the pentafluorostyrene groups have been functionalized such that one of the carbon atoms on the benzene ring includes a styrenic moiety as a substituent (herein referred to as “TYPE #1 POLYMERS”):

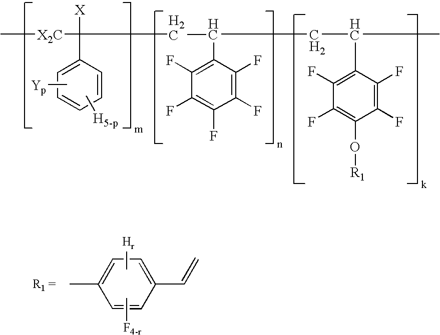

p=0, 1, 2, 3, 4, or 5,

q=0, 1, 2, 3, 4, or 5,

r=0, 1, 2, 3, or 4,

X=independently selected from H, D, and F,

Y=Independently selected from F and D, and

m, n, and k are non-zero integers.

For TYPE #1 POLYMERS depicted above for use as buffer or cladding polymers, the ratio (m:n:k) is typically (about 5 to about 30:about 40 to about 90:about 5 to about 25), preferably (about 10 to about 25:about 50 to about 80:about 8 to about 20), and more preferably (about 15 to about 25:about 55 to about 70:about 10 to about 15). However, in certain embodiments other ratios may be preferred.

For TYPE #1 POLYMERS depicted above for use as guiding polymers, the ratio (m:n:k) is typically (about 5 to about 30:about 40 to about 90:about 10 to about 35), preferably (about 10 to about 25:about 50 to about 80:about 10 to about 30), more preferably (about 15 to about 20:about 55 to about 70:about 15 to about 25); and most preferably (about 0.2:about 0.6:about 0.2). However, in certain embodiments other ratios may be preferred.

The preferred molecular weight for a TYPE #1 POLYMER may vary depending upon the processing conditions or device to be fabricated. However, the molecular weight is preferably from about 15K or less to about 80K or more, more preferably from about 25K to about 70K, and most preferably from about 30K to about 45 or 55K.

Preparation of Type #1 Polymers

In a preferred embodiment, polymers are prepared using styrene (ST), either unsubstituted or suitably substituted as described herein, and 2,3,4,5,6-pentafluorostyrene (PFS), either unsubstituted or suitably substituted as described herein, as starting materials to produce a base polymer, which is then functionalized to provide styrenic crosslinking groups. The polymers may be prepared according to the following reaction scheme. In this example, the ST and PFS starting materials are unsubstitued. However, the scheme, optionally with slight modification, may also be used to prepare polymers from other starting materials including appropriate functional groups.

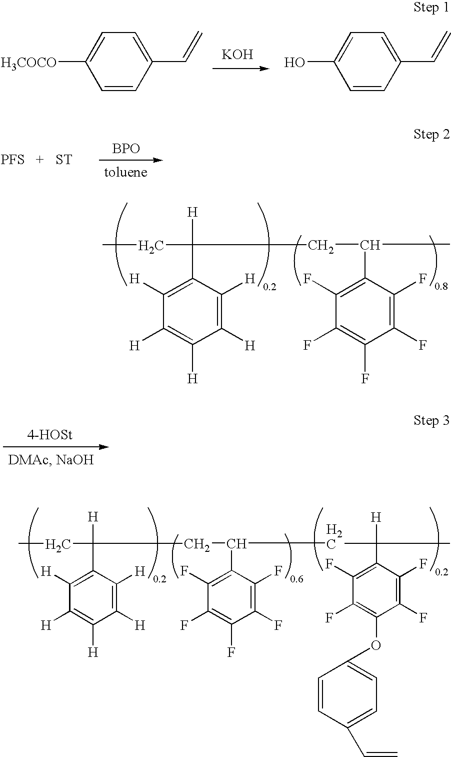

Although benzoyl peroxide (BPO) is employed as an initiator in the scheme shown above, other initiators may also be suitable for use.

For the specific TYPE #1 POLYMER depicted in the scheme above, the ratios of the monomers are 0.6 moles PFS to 0.2 moles ST to about 0.2 vinylphenylether (VPE). For other TYPE #1 POLYMERS, however, the ratio of the monomers may vary, depending upon the desired properties of the resulting polymer. However, in general, the polymer typically includes from about 8 to about 16 moles PFS to about 1 to about 6 moles ST to about 2 to about 7 moles VPE, preferably from about 10 to about 40 moles PFS to about 2 to about 5 moles ST to about 2 to about 6 moles VPE, and more preferably from about 11 to about 14 moles PFS to about 3 to about 5 moles ST to about 3 to about 5 moles VPE. These ratios are generally characteristic of a polymer with preferred physical and optical properties desirable in a guiding material. In other embodiments, the ratios of the monomers can be adjusted to obtain polymers with different physical and optical properties. In general, as the proportion of PFS in the polymer increases, the T_{g}, and T_{d} increase while maintaining desirable optical properties in the resulting polymer.

In Step 1 depicted above, 4-acetoxystyrene is reacted with potassium hydroxide at 0° C. under a nitrogen atmosphere. The reaction proceeds without a catalyst. Preferred reaction times for Step 1 are from about 2 to about 6 hours, more preferably from about 2.5 to about 5 hours, and most preferably from about 3 to about 4.5 hours, however in certain embodiments longer or shorter reaction times may be preferred. Preferred reaction temperatures are from about 0° C. to about 20° C., more preferably from about 0° C. to about 15° C., and most preferably from about 0° C. to about 10° C. However, in certain embodiments, higher or lower reaction temperatures may be preferred. After the reaction is completed, from about 10 mol. % or less to about 40 mol. % or more of 4-acetoxystyrene may remain unreacted. Typically about 15 to about 35 mol. % 4-acetoxystyrene remains unreacted, and more typically about 20 to about 30 mol % 4-acetoxystyrene remains unreacted. In certain embodiments, however, less 4-acetoxystyrene may remain unreacted.

In Step 2 depicted above, the base polymer is prepared by free radical polymerization using benzoyl peroxide or azodiisobutyronitrile as an initiator. Typically from about 0.2 to about 2.5 mol. % (based on the total moles of monomer) of initiator is present, preferably about 0.5 to about 2.0 mol. %, and more preferably about 0.8 to about 1.5 mol. %. However, in certain embodiments, more or less initiator may be present. Preferred reaction times for Step 2 are from about 10 to about 48 hours, more preferably from about 15 to about 36 hours, and most preferably from about 20 to about 30 hours, however in certain embodiments longer or shorter reaction times may be preferred. Preferred reaction temperatures are from about 40° C. to about 90° C., more preferably from about 50° C. to about 80° C., and most preferably from about 60° C. to about 75° C. However, in certain embodiments, higher or lower reaction temperatures may be preferred. After the reaction is completed, from about 5 mol. % or less to about 30 mol. % or more of base monomer may remain unreacted. Typically, about 10 to about 25 mol. % of base monomer remains unreacted, and more typically about 15 to about 20 mol % of base monomer remains unreacted. In certain embodiments, however, less base monomer may remain unreacted.

In Step 3 depicted above, the base polymer is reacted with NaH and 4-hydroxystyrene. No catalyst is required. Preferred reaction times for Step 2 are from about 2 to about 6 hours, more preferably from about 2.5 to about 5.5 hours, and most preferably from about 3 to about 5 hours, however in certain embodiments longer or shorter reaction times may be preferred. Preferred reaction temperatures are from about 90° C. to about 120° C., more preferably from about 95° C. to about 115° C., and most preferably from about 100° C. to about 110° C. However, in certain embodiments, higher or lower reaction temperatures may be preferred. After the reaction is completed, typically less than about 5 mol. % of monomer remains unreacted, more preferably less than about 3 mol. % of monomer remains unreacted, and most preferably less than about 2 mol. % of monomer remains unreacted. In certain embodiments, however, it may be desirable to have more monomer remain unreacted. In general, it is preferred to functionalize from about 5% or less to about 60% or more of the pentafluorostyrene moieties of the base polymer with a VPE moiety, more preferably from about 6, 7, 8, or 9% to about 25, 30, 35, 40, 45, 50, or 55%, and most preferably about 10, 11, 12, 13, 14, 15, 16, 17, 18, or 19% to about 20, 21, 22, 23, or 24%. However, in certain embodiments, a lower or higher degree of functionalization may be preferred.

While the above description is primarily directed to TYPE #1 POLYMERS using the specified compounds as starting materials, the preferred reaction conditions and characteristics of the resulting polymer also apply to other TYPE #1 POLYMERS.

TYPE #1 POLYMER Guiding Materials

A TYPE #1 POLYMER may be deposited on a suitable substrate from solution to form a guiding layer. Any suitable solvent may be employed. However, cyclopentanone, n-propylacetate, and n-butylacetate are particularly preferred. In preferred embodiments a TYPE #1 POLYMER solution will typically contain from about 30 to about 50 wt. % solids, more preferably from about 35 to about 45 wt. % solids, and most preferably from about 37 to about 42 wt. % solids. When cyclopentanone is the solvent, it is preferably present at about 40 to about 70 wt. %, more preferably at about 45 to about 65 wt. %, and most preferably at about 50 to about 60 wt. %. When the solvent is n-butyl acetate, it is typically present as a cosolvent with cyclopentanone, and is typically present at about 25 wt. % or less, preferably at about 20 wt. % or less, and more preferably at about 15 wt. % or less. In a particularly preferred embodiment, 40 wt. % TYPE #1 POLYMER is dissolved in 60 wt. % cyclohexanone.

A photoinitiator is added to the solution so as to permit the deposited polymer to be patterned with UV light. Preferred initiators include RH and CTX. When the initiator is RH, it is typically present at about 2 to about 8 wt. %, more preferably at about 3 to about 7 wt. %, and most preferably at about 4 to about 6 wt. %. When the initiator is CTX, it is typically present at about 0.5 to about 3 wt. %, preferably at about 1 to about 2.5 wt. %, and more preferably at about 1 to about 2 wt. %. In a particularly preferred embodiment, 4 wt. % RH (based on solids content) and 1.2 wt. % CTX (based on solids content) is employed. After the initiator is added to the solution, the solution is stirred. The solution viscosity is preferably about 100±10 cP at 21° C. However, in certain embodiments higher or lower viscosities may be preferred. The solution is filtered through a 0.2 μm filter and preferably stored under refrigeration at a constant temperature of 20° C. in a dry amber jar until use.

When a TYPE #1 POLYMER is to be used as a guiding layer, the ratio (m:n:k) is typically (about 5 to about 30:about 30 to about 90:about 10 to about 35), preferably (about 10 to about 25:about 40 to about 80:about 10 to about 30), more preferably (about 15 to about 20:about 50 to about 70:about 15 to about 25), and most preferably (about 0.2:about 0.6:about 0.2). The preferred molecular weight for TYPE #1 POLYMER when it is to be used in a guiding layer is about 15K to about 80K, more preferably from about 25K to about 70K, and most preferably from about 30K to about 55K. In certain particularly preferred embodiments, the physical characteristics of the TYPE #1 POLYMER prepared as described above for use in a guiding layer preferably substantially meet target values including a Tg of about 104° C. (before crosslinking), a decomposition temperature (T_{dec.}) of about 422° C., a polydispersity of about 1.82, and a purity of ≧99%. Results of FTIR analysis preferably indicate that the ratio of ST:VPE:PFS is about 2.1:2.8:1, and the polymer preferably has a molecular weight of 50K.

TYPE #1 POLYMER Cladding and Buffer Materials

While TYPE #1 POLYMERS are particularly preferred for use as guiding polymers, they are also suitable for use as cladding or buffer polymers. Solutions of TYPE #1 POLYMERS for preparing cladding or buffer layers may be prepared using any suitable solvent. However, cyclopentanone, n-propylacetate, and n-butylacetate are particularly preferred. In preferred embodiment, a TYPE #1 POLYMER solution will typically contain from about 30 to about 50 wt. % solids, more preferably from about 35 to about 45 wt. % solids, and most preferably from about 37 to about 42 wt. % solids. When cyclopentanone is the solvent, it is preferably present at about 40 to about 70 wt. %, more preferably at about 45 to about 65 wt. %, and most preferably at about 50 to about 60 wt. %. When the solvent is n-butyl acetate, it is typically present as a cosolvent with cyclopentanone, and is typically present at about 25 wt. % or less, preferably at about 20 wt. % or less, and more preferably at about 15 wt. % or less. In a particularly preferred embodiment, 40 wt. % TYPE #1 POLYMER is dissolved in 60 wt. % cyclohexanone.

A catalyst is then added to the solution so as to permit the deposited polymer to cure. A preferred catalyst includes BPO. When the catalyst is BPO, it is typically present at about 1 to about 5 wt. %, more preferably at about 1.5 to about 4 wt. %, and most preferably at about 2 to about 3 wt. %. After the catalyst is added to the solution, the solution is stirred. The solution viscosity is preferably about 100±10 cP at 21° C. However, in certain embodiments, higher or lower viscosities may be preferred. The solution is filtered through a 0.2 μm filter and preferably stored under refrigeration at a constant temperature of 20° C. in a dry amber jar until use.

When TYPE #1 POLYMER is to be used in a cladding or buffer layer, the ratio (m:n:k) is typically (about 5 to about 30:about 30 to about 90:about 5 to about 25), preferably (about 10 to about 25:about 40 to about 80:about 8 to about 20), more preferably (about 15 to about 20:about 50 to about 70:about 10 to about 15), and most preferably (about 0.2:about 0.6:about 0.2). The preferred molecular weight for a TYPE #1 POLYMER when it is to be used in a cladding or buffer layer is about 15K to about 80K, more preferably from about 25K to about 70K, and most preferably from about 30K to about 50K. In certain particularly preferred embodiments, the physical characteristics of the TYPE #1 POLYMER prepared as described above for use in a cladding layer preferably substantially meet target values including a Tg of about 104° C. (before crosslinking), T_{dec} of about 422° C., a polydispersity of about 1.82, and a purity of ≧99%. Results of FTIR analysis preferably indicate that the ratio of ST:VPE:PFS is about 2.0:1.4:1, and the polymer preferably has a molecular weight of 45K.

Polymeric Materials with Epoxy Crosslinking Group

As discussed above, in certain preferred embodiments, the polymeric materials that form optical devices are selected from a class of styrene-containing polymeric materials. These materials include a styrene moiety as a crosslinking group. However, in certain embodiments, it may be preferred to utilize an epoxy group as a crosslinking group.

TYPE #2 POLYMERS

In a preferred embodiment, the polymeric materials include copolymers of styrene (optionally substituted as described herein) and 2,3,4,5,6-pentafluorostyrene (optionally substituted as described herein), wherein a number of the pentafluorostyrene groups have been functionalized such that one of the carbon atoms on the benzene ring includes an epoxy moiety as a substituent (herein referred to as “TYPE #2 POLYMERS”).

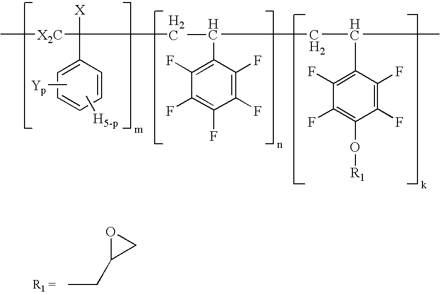

p=0, 1, 2, 3, 4, or 5,

q=0, 1, 2, 3, 4, or 5,

r=0, 1, 2, 3, or 4,

X=independently selected from H, D, and F,

Y=Independently selected from F and D, and

m, n, and k are non-zero integers.

When a TYPE #2 POLYMER is to be used as a guiding layer, the ratio (m:n:k) is typically (about 5 to about 30:about 30 to about 90:about 10 to about 35), preferably (about 10 to about 25:about 40 to about 80:about 10 to about 30), more preferably (about 15 to about 20:about 50 to about 70:about 15 to about 25), and most preferably (about 0.2:about 0.6:about 0.2). The preferred molecular weight for TYPE #2 POLYMER when it is to be used in a guiding layer is about 15K to about 80K, more preferably from about 25K to about 70K, and most preferably from about 30K to about 55K.

When TYPE #2 POLYMER is to be used in a cladding or buffer layer, the ratio (m:n:k) is typically (about 5 to about 30:about 30 to about 90:about 5 to about 25), preferably (about 10 to about 25:about 40 to about 80:about 8 to about 20), more preferably (about 15 to about 20:about 50 to about 70:about 10 to about 15), and most preferably (about 0.2:about 0.6:about 0.2). The preferred molecular weight for a TYPE #2 POLYMER when it is to be used in a cladding or buffer layer is about 15K to about 80K, more preferably from about 25K to about 70K, and most preferably from about 30K to about 50K.

Preparation of TYPE #2 POLYMERS

TYPE #2 POLYMERS may be prepared using a similar synthetic route as that provided for TYPE #1 POLYMERS, except that glycidol (GOL) is substituted for 4-hydroxystyrene. The resulting polymers, referred to as TYPE #2 POLYMERS, may be prepared according to the following reaction scheme:

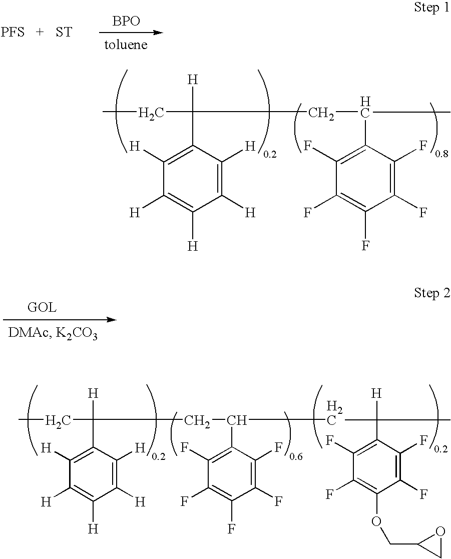

Preferred reaction conditions for Step 1 is the same as for the reaction scheme for the TYPE #1 POLYMERS. Preferred monomer ratios are also the same as those for TYPE #1 POLYMERS. In Step 2 depicted above, the base polymer is reacted with K₂CO₃ and glycydol. Preferred reaction conditions for Step 3 for preparing TYPE #2 POLYMERS are otherwise the same as for Step 3 for preparing TYPE #1 POLYMERS. The preferred molecular weight for TYPE #2 POLYMERS may vary depending upon the processing conditions or device to be fabricated. However, preferred molecular weights are generally the same as those for TYPE #1 POLYMERS. Guiding layers, cladding layers, or buffer layers may be prepared as described above for TYPE #1 POLYMERS by an appropriate substitution of TYPE #2 POLYMER for the TYPE #1 POLYMER. The catalysts, photoinitiators, and photosensitizers employed are the same as for TYPE #1 POLYMERS

TYPE #3 POLYMERS

In a preferred embodiment, optical materials are prepared from copolymers of styrene (optionally substituted, as described herein) and glycidyl methacrylate (GMA) (herein referred to as “TYPE #3 POLYMERS”):

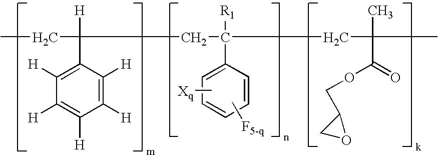

q=0, 1, 2, 3, 4, or 5,

p=0, 1, 2, 3, 4, 5, 6, 7, 8, 9, or 10,

y=1, 2, 3, or 4,

R₁=CH₃; or H, and

X=Cl; Br; CF₃; —(CF₂)ₚ—CF₃;

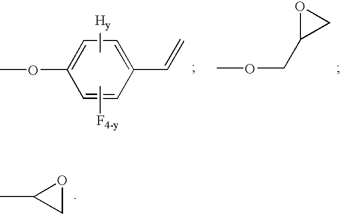

For TYPE #3 POLYMERS depicted above, the preferred ratios (m:n:k) are similar to those for TYPE #1 POLYMERS and TYPE #2 POLYMERS. Generally, (m:n:k) is (about 5 to about 30:about 30 to about 90:about 5 to about 40), preferably (about 10 to about 25:about 40 to about 80:about 10 to about 35), more preferably (about 15 to about 20:about 50 to about 70:about 15 to about 30), and most preferably (about 2.0:about 6.0:about 2.0). However, in certain embodiments, other ratios, either higher and/or lower, may be preferred. The preferred molecular weight is typically from about 20K to 100K, more preferably from about 25 to about 90K, and most preferably from about 30 to about 70K.

TYPE #3 POLYMERS may be prepared by known synthetic routes, such as free radical polymerization. One such route is the copolymerization of styrene, substituted fluorostyrene, and allyl glycidyl ether in the presence of a catalyst, such as benzoyl peroxide, at elevated temperature. The synthetic routes disclosed in copending application Ser. No. 10/123,052 filed on Apr. 12, 2002, the contents of which is hereby incorporated by reference in its entirety, may be modified using the knowledge of one skilled in the art of polymer synthesis to prepare TYPE #3 POLYMERS. The resulting polymer may optionally be fanctionalized using a method similar to that depicted in Step 3 of the TYPE #1 POLYMER synthesis depicted above, with appropriate modification, as will be appreciated by one skilled in the art.

An exemplary synthetic method is as follows. Styrene, glycidyl methacrylate, and PFS are subjected to free radical polymerization using benzoyl peroxide (BPO) or azodiisobutyronitrile (AIBN) as an initiator. Typically the initiator is present at about 0.2 to about 2.5% (based on total moles of the monomers), preferable at about 0.5 to about 2.0%, and more preferably at about 0.7 to about 1.5%. The reaction time is typically about 10 to about 48 hours, preferably about 15 to about 36 hours, and more preferably about 20 to about 20 hours. However, in certain embodiments, longer or shorter reaction times may be desirable. The reaction temperature is typically about 40° C. to about 100° C., preferably from about 50° C. to about 90° C., and more preferably from about 60° C. to about 80° C. However, in certain embodiments higher or lower reaction temperatures may be preferred. Typically about 5 to about 30 wt. % or less of the monomer remains unreacted at the end of the polymerization reaction, preferably about 10 to about 25 wt. % or less, and more preferably about 15 to about 20 wt. % or less.

In certain particularly preferred embodiments, the physical characteristics of the TYPE #3 POLYMER prepared as described above for use in a cladding layer preferably substantially meet target values including a Tg of about 90° C. (before crosslinking), T_{dec} of about 390° C., a polydispersity of about 1.92, and a purity of ≧99%. Results of FTIR analysis preferably indicate that the ratio of ST:GMA:PFS was 2.0:3.5:1, and the polymer preferably has a molecular weight of 45K.

TYPE #3 POLYMER may be deposited on a suitable substrate from solution to form a buffer or cladding layer. Any suitable solvent may be employed. However, cyclopentanone, n-propylacetate, n-butylacetate, and y-butyrolactone are particularly preferred. In preferred embodiments a TYPE #3 POLYMER solution will typically contain from about 30 to about 50 wt. % solids, more preferably from about 35 to about 50 wt. % solids, and most preferably from about 40 to about 48 wt. % solids. When cyclopentanone is the solvent, it is preferably present at about 30 to about 60 wt. %, more preferably at about 35 to about 55 wt. %, and most preferably at about 40 to about 50 wt. %. When the solvent is γ-butyrolactone, it is typically present as a cosolvent with cyclopentanone, and is typically present at about 5 to about 25 wt. %, preferably at about 5 to about 20 wt. %, and more preferably at about 10 to about 15 wt. %. A curing catalyst, such as DBU is added to the solution, preferably at about 2 to about 10 wt. % (based on the polymer), more preferably at about 3 to about 8 wt. %, and most preferably about 4 to about 6 wt. %.

In a particularly preferred embodiment, 45 wt. % TYPE #3 POLYMER is dissolved in 44 wt. % cyclohexanone and 11 wt. % γ-butyrolactone. DBU (5.2 wt. % based on solids content) is added to the solution as a catalyst and the solution is stirred. The solution viscosity is preferably about 350±50 cP at 21° C. However, in certain embodiments higher or lower viscosities may be preferred. The solution is filtered through a 0.2 μm filter and preferably stored under refrigeration at a temperature of 0-5° C. in a dry amber jar until use.

Although the above description is directed to the use of TYPE #3 POLYMER in a buffer or cladding layer solution, the polymer may also be used to prepare guiding layers. When a guiding layer is to be prepared, a photoinitiator is substituted for the catalyst. As will be appreciated by one skilled in the art, methods for preparing solutions for use in preparing guiding layers as described above for TYPE #1 POLYMERS or TYPE #2 POLYMERS may be appropriately modified so as to prepare solutions of TYPE #3 POLYMERS.

The disclosure below is of specific examples setting forth methods for making the materials and devices in accordance with preferred embodiments. These examples are not intended to limit the scope, but rather to exemplify preferred embodiments.

### EXAMPLE 1

### Preparation and Characterization of PFS-ST Base Copolymer

A base polymer comprising 2,3,4,5,6-pentafluorostyrene and styrene was prepared. A mole ratio of PFS:ST of 80:20 was selected for the base copolymer. The quantities of reagents for the reactions were calculated as follows. The weight of ST for a given weight of PFS was calculated according to the following equation:

$$\frac{( \frac{{M}_{PFS}}{{Mmol}_{PFS}} ) \times 20}{80} = NumMol \cdot Styrene$$

NumMol•Styrene×Mmol•Styrene=Mass•Styrene(g)

The mean molecular weight of the base copolymer having the above monomer ratio was calculated according to the following equation:

(Mmol_{PFS}*0.8)+(0.2*Mmol_{styrene})=\overline{M}molar•

(194.10 g/mol*0.8)+(0.2*104.15 g/mol)=176.11 g/mol

When a scale-up (or scale-down) of the polymerization reaction is performed, it may be necessary to adjust the quantities of raw materials to obtain the desired molecular weight. The ratios between the required raw materials may not always be linear.

The materials were purified prior to use in the reactions. PFS and ST were each injected individually into a purification column containing an appropriate “inhibitor remover” (Aldrich Cat. No. 31,133-2, HQ/MEHQ for PFS, and Aldrich Cat. No. 31,134-0, tert-butylcatechol for ST). The purity of the reagents was determined by Gas Chromatography-Mass Spectrometry (GC-MS).

Benzoyl peroxide (BPO) was purified by a recrystallization method as follows. Ten grams of BPO was added to 100 ml of methanol. The solution was heated to dissolve the BPO. The solution was cooled to room temperature to allow crystallization of BPO. The recrystallized BPO was collected by vacuum filtration. The BPO was washed with methanol, then air-dried for 12 hours. The purity of BPO was determined by High Pressure Liquid Chromatography (HPLC).

The polymerization reaction was conducted as follows. First, a 1000-ml three-neck flask was flame-dried and cooled with nitrogen. Under a fume hood, 200 g of PFS (Aldrich, >99% purity) and 26.83 g ST (Spectrum, >99% purity) were weighed into the flask. 3.12 g of recrystallized BPO (Anachemia, >70% purity before recrystallization) were weighed out and added to the contents of the flask. With a graduated cylinder, 500 ml of toluene were measured and added to the flask. The walls of the flask were rinsed while adding the toluene to the flask. The solution in the flask was stirred under a continuous stream of nitrogen flow to fully dissolve the BPO. Once the BPO was fully dissolved, the heating process was initiated by raising the temperature of the solution gradually over a 1 hour period from room temperature to 70±1° C. The polymerization reaction was allowed to proceed over the next 20 hours. The heat was then removed and the solution cooled to room temperature. The solution viscosity was adjusted to 9.8 cP at room temperature (˜20° C.) by adding toluene.

Next, the base copolymer was precipitated. The amount of methanol to initiate precipitation of the polymer was calculated according to the following equation:

Vol. Methanol=12×Vol. Toluene

The methanol was added to a beaker equipped with a stirring bar, and the polymer solution was added dropwise to the methanol. A white polymer precipitated during slow addition of methanol with stirring at room temperature. The polymer was collected by vacuum filtration with a fritted glass filter. The precipitated polymer was washed twice with methanol. The polymer was dried for 4 hours using vacuum filtration. After redissolving the polymer in 600 ml toluene, the polymer was again precipitated as described above. The polymer then was collected by vacuum filtration with a fritted glass filter, washed three times with methanol, and dried for 16 hours in a petri dish. The polymer was further dried in an oven at 40° C. for 24 hours. The yield of the polymer was approximately 65-68% (based on the total weight of ST and PFS reacted). The resulting polymer was stored in a flame-dried hermetic tinted jar kept in a dessicator.

Samples of base copolymer prepared as described above were characterized using differential scanning calorimetry (DSC) and thermogravimetric analysis (TGA) to determine Tg and the decomposition temperature (T_{dec.}). The results of the analysis are provided in Table 1.

TABLE 1

| Sample Number | Tg (° C.) | T_{dec.} (° C.) | Purity (%) |
|---|---|---|---|
| CoPFS/Sty-1 | 104 | — | — |
| CoPFS/Sty-2 | 104 | 422 | — |
| CoPFS/Sty-3 | 106 | — | — |
| CoPFS/Sty-4 | 105 | — | — |
| CoPFS/Sty-5 | 103 | 430 | 99.81 |
| CoPFS/Sty-6 | — | — | 99.32 |
| CoPFS/Sty-7 | 101 | 432 | 99.69 |
| CoPFS/Sty-8 | — | — | 99.86 |

Purities of samples of base copolymer prepared as described above were analyzed by dry weight (30 minute isotherm at 150° C.). The results of the analysis are provided in Table 2.

TABLE 2

| | Purity |
|---|---|
| Sample Number | (wt. %) |
| CoPFS/Sty-1 | 99.72% |
| CoPFS/Sty-2 | 98.03% |
| CoPFS/Sty-3 | 97.87% |
| CoPFS/Sty-4 | 99.39% |
| CoPFS/Sty-5 | 98.72% |
| CoPFS/Sty-6 | 98.55% |
| CoPFS/Sty-7 | 98.71% |
| CoPFS/Sty-8 | 98.60% |
| CoPFS/Sty-9 | 98.89% |

### EXAMPLE 2

### Preparation and Characterization of 4-4-Hydroxystyrene Functionalizing Agent

4-4-hydroxystyrene was prepared by reacting 4-acetoxystyrene with potassium hydroxide (KOH). For the reaction, 2.6 moles KOH 99.99% were present for each mole of 4-acetoxystyrene, so the quantity of KOH for a given weight of 4-acetoxystyrene was calculated as follows:

$$[ ( \frac{{M}_{Acétoxystyrene}}{Mmol {.}_{Acétoxystyrene}} ) \times 2.6 eq ] \times M {mol}_{KOH99 .99 \%} = {M}_{KOH}$$

A water/ice bath was prepared in a petri dish equipped with a magnetic stirrer and maintained at a temperature of 0-5° C. 360 ml of deionized water was added to a 1000-ml three-neck flask. 40 grams of 4-acetoxystyrene (96% purity) were measured directly into the flask, and a magnetic stir bar was placed in the flask. A Dean-Stark trap was fastened to the flask and its openings were closed with septums. A water/ice bath was prepared in a petri dish and maintained at a temperature of 0-5° C. The Dean-Stark trap was placed in the water/ice bath. A bubble gauge needle was connected to the septum used to close the opening of the Dean-Stark trap, and nitrogen was gently flowed into the setup. The volume of nitrogen was controlled with the bubble gauge. The solution was stirred using a medium level of agitation (between 4-6 on a scale of 10).

36 grams of KOH (99.99% purity, electronic grade) were added to the reaction solution. The reaction proceeded for 3 hours. The temperature of the water/ice bath was maintained at 0-5° C. for the duration of the reaction. 20 grams of glacial acetic acid were added to control the pH of the reaction mixture, then 100 ml of de-ionized water was added. The solution was filtered on a 500-ml vacuum Erlenmeyer flask/Buchner funnel/Paper filter setup. The resulting monomer was washed twice with 100 ml of de-ionized water each time. The monomer was placed in a petri dished covered with aluminum foil and maintained for 8-12 hours under a fume hood.

The monomer was weighed and poured in a 1000-ml three-neck flask. The 1000 ml three-neck flask was equipped with a heating mantle and connected to a Graham trickling condenser. A temperature sensor connected to the heating system is inserted into one of the two remaining openings of the flask. A quantity of hexane corresponding to 30 times the quantity of monomer to be treated is added to the flask. As the amount of monomer was approximately 25 grams, 750 ml of hexane was added. The last opening of the flask was closed by a septum, and the flask was heated at 55° C. over a 30-minute period.

The solution was filtered through a 1-liter Erlemneyer flask/Buchner funnel setup preheated to 45° C. The solution was refrigerated for three hours, resulting in the formation of white crystals of 4-hydroxystyrene. The crystals were filtered, then washed twice with hexane. The crystals were collected in an amber glass jar and allowed to dry in a vacuum oven at room temperature for over 5 hours. The crystals were then stored in an amber jar sealed with paraffin in a refrigerator at 4° C. until use. The yield of 4-hydroxystyrene was 81 mol. % (compared to the weight of 4-acetoxystyrene reacted).

Samples of 4-hydroxystyrene prepared as described above were characterized using DSC to determine fusion point (T_{f}) and ΔH. The results of the analysis are provided in Table 3.

TABLE 3

| | T_{f} | ΔH |
|---|---|---|
| Sample Number | (° C.) | (J/g) |
| p-OHsty-1 | 69.7 | 100.0 |
| p-OHsty-2 | 71.7 | 135.4 |
| p-OHsty-3 | 73.1 | 138.5 |
| p-OHsty-4 | 74.3 | 116.9 |

T_{f} and purities of samples of 4-hydroxystyrene prepared as described above were characterized using DSC. The results of the analysis are provided in Table 4.

TABLE 4

| Sample Number | T_{f} (° C.) | Mol. % impurity |
|---|---|---|
| POHsty-1 | 71.0 | 0.13 |
| POHsty-2 | 71.0 | 0.25 |
| POHsty-3 | 70.9 | 0.42 |
| POHsty-4 | 71.7 | 0.16 |
| POHsty-5 | 70.9 | 0.31 |
| POHsty-6 | 70.9 | 0.21 |
| POHsty-7 | 70.9 | 0.25 |
| POHsty-8 | 70.5 | 0.34 |
| POHsty-9 | 71.2 | 0.38 |
| POHsty-10 | 70.2 | 0.64 |
| POHsty-11 | 70.0 | 0.43 |
| POHsty-12 | 70.9 | 0.23 |
| POHsty-13 | 69.9 | 0.40 |

### EXAMPLE 3

### Preparation and Characterization of a Guiding Layer Polymer

A polymer having styrenic moieties as the crosslinking groups was prepared using as starting materials the PFS-ST base copolymer of Example 1 and the 4-hydroxystyrene of Example 2. The mole ratio PFS:ST of the base copolymer was 80:20. The quantities of reagents for the reactions were calculated as follows. The mean molecular weight of the base copolymer having the above monomer ratio was calculated according to the following equation:

(Mmol_{PFS}*0.8)+(0.2*Mmol_{styrene})=\overline{M}molar•

(194.10 g/mol*0.8)+(0.2*104.15 g/mol)=176.11 g/mol

The quantity (in moles) of base copolymer to prepare a given amount of functionalized copolymer was calculated according to the following equations:

$$\begin{matrix}( \frac{{M}_{co \text{-} PFS \text{/} Styrene}}{\overline{{M}_{molaire}}} ) mol \cdot of \cdot co \text{-} PFS \text{/} Styrene \\ ( \frac{30.00 g}{176.11 g \text{/} mol} ) = 0.1703 mol\end{matrix}$$

The quantity (in grams) of 4-hydroxystyrene (or 4-hydroxystyrene) to functionalize 20% of the PFS monomers was calculated according to the following equations:

(Nbmol_{Co-PFS/Styrene}*20%)*Mmol_{parahydroxystrene}=M_{parahydroxystyrene}

[(0.1703*20%)]*120.15 g/mol=4.092 g

The quantity (in grams) of NaH for the functionalization reaction was calculated according to the following equation:

Nbmol_{parahydroxystyrene}*1.05*Mmol_{sodiumhydrid}=M_{sodiumhydride}

0.0334 mol*1.05*24.00 g/mol=0.840 g

The quantity (in ml) of DMAc for the functionalization reaction was calculated according to the following equations:

M_{polymer}×10=V_{DMAc}

30 g×10=300 ml.

Polymer Preparation

A 500-ml three-neck flask was flame dried and equipped with a stirring bar and a Dean-Stark trap. The flask and Dean-Stark trap were cooled with nitrogen streams and all openings were immediately closed with septums. The Dean-Stark trap was connected to the three-neck flask, which was then installed in an oil bath. A clean 30 cm needle was flame dried and cooled with a nitrogen stream, then set at the end of a syringe containing a dessicant (Drierite). A needle connected to a hose of a bubble gauge was then inserted in the septum used to close the Dean-Stark trap, and nitrogen was allowed to gently flow into the setup. The amount of injected nitrogen was controlled with the bubble gauge.

4.085 g of 4-hydroxystyrene prepared as in Example 2 was added to the three-neck flask. A30-cm stainless-steel needle was flame dried, cooled with a nitrogen stream, and inserted into the end of a 60-ml syringe and used to add 60 ml of anhydrous dimethylacetamide (DMAc) (Aldrich, 98.9% purity) to the flask. An additional 60 ml of DMAc was then injected, and stirring of the solution was initiated. The injection procedure was repeated until a total of 300 ml of DMAc was injected.

The interior of the neck through which the DMAc has been injected was wiped clean and the neck immediately closed. 30 g of base copolymer prepared in Example 1 was added to the three-neck flask. The polymer was allowed to solubilize completely over 30-40 minutes. 0.420 g of NaH was added to the reaction solution. The reaction was allowed to proceed for approximately 20 minutes, after which additional NaH was added such that the total weight of NaH was 820 mg. The reaction was allowed to proceed for approximately an hour. The temperature of the reaction to was increased from 20° C. to 106° C. over the course of an hour, then the reaction was allowed to proceed for another 2.5 hours. The solution was then cooled to 40° C. 2.5 ml iodomethane (Spectrum, 99.5% purity) was added to the solution, and the reaction was permitted to proceed for 30 minutes.

3 liters of methanol and a magnetic stirring bar were added to a 4-liter beaker, followed by 15 ml of acetic acid, after which stirring of the mixture commenced. The reaction mixture was poured from the three-neck flask into an addition funnel suspended over the 4-liter beaker, and then the funnel valve was opened to permit the reaction solution to flow into the beaker. The resulting precipitated polymer was filtered through a fritted glass filter, then washed twice with 75 ml of methanol per wash. After drying the polymer on the filter, it was stored in a petri dish covered with perforated aluminum and allowed to air dry overnight until a mass of ≦50 grams was achieved. If after drying overnight the mass is still >50 g, then the polymer is placed in a vacuum oven until the mass is ≦50 g.

The polymer was then purified in a first purification step. The polymer was added to a 500-ml beaker along with a magnetic stirring bar. 280 ml of toluene was then added, and the mixture was stirred until the polymer was fully dissolved. The solution was allowed to stand without stirring for approximately 2 hours, after which the resulting polymer solution was filtered with a vacuum filtering setup comprising a 500-ml vacuum Erlenmeyer, one Buchner funnel, and a paper filter (qualitative 410). The Buchner funnel was filled with Celite Diatomite (Celite Corporation of Quincy, Wash.) to within 1 cm of its top. The mixture of polymer in toluene was poured over the Celite. 200 ml of a clear, light yellow polymer solution was obtained.

A 2-liter beaker filled with methanol, 10 ml of acetic acid, and a magnetic stirring bar. Stirring was initiated, and the polymer solution was poured into the 2-liter beaker, resulting in precipitation of the polymer. The polymer was vacuum-filtered with a fritted glass filter, washed twice with 75 ml of methanol per washing, and allowed to dry on the filter.

The resulting polymer powder was placed in a petri dish covered with perforated aluminum foil and allowed to stand overnight. The polymer was weighed. If the mass was greater than 50 grams, the polymer was placed in a vacuum oven at room temperature to further dry the polymer until the mass was ≦50 grams.

The polymer was then purified in a second purification step. The polymer was added to a 500-ml beaker along with a magnetic stirring bar. 240 ml of toluene was then added, and the mixture was stirred until the polymer was fully dissolved. The solution was allowed to stand for approximately 2 hours, after which the resulting polymer solution was filtered with a vacuum filtering setup as described in the first purification step to yield 200 ml of a clear, light yellow polymer solution. The solution was further filtered with a 0.2 μm filter.

A 2-liter beaker was filled with methanol, 10 ml of acetic acid, and a magnetic stirring bar. Stirring was initiated, and the polymer solution was poured into the 2-liter beaker, resulting in precipitation of the polymer. The solution was allowed to stand for approximately 2 hours, after which the resulting mixture was filtered using a vacuum filtering setup comprising a vacuum Erlenmeyer flask and Buchner funnel into which a paper filter (qualitative 410) was placed. The polymer was washed twice with 50 ml of methanol per washing, and allowed to dry on the filter.

The resulting polymer powder was placed in a petri dish covered with perforated aluminum foil and allowed to stand overnight. The polymer was then dried in a vacuum oven at room temperature for 5 days.

Samples of the functionalized guiding polymer prepared as described above were characterized using gel permeation chromatography (GPC) to determine molecular number (Mn), molecular weight (Mw), and polydispersity (PD).

GPC was used to determine molecular number (Mn), molecular weight (Mw), and polydispersity (PD) for samples of the functionalized guiding polymer prepared as described above. The results of the analysis are provided in Table 5.

TABLE 5

| Sample Number | Mn | Mw | PD |
|---|---|---|---|
| Guide-1 | 27.2K | 49.5K | 1.82 |
| Guide-2 | 29.0K | 52.7K | 1.81 |
| Guide-3 | 28.7K | 50.9K | 1.77 |
| Guide-4 | 27.5K | 48.9K | 1.78 |
| Guide-5 | 28.0K | 48.5K | 1.74 |
| Guide-6 | 28.3K | 49.9K | 1.76 |
| Guide-7 | 27.1K | 48.1K | 1.78 |
| Guide-8 | 26.0K | 49.1K | 1.89 |
| Guide-9 | 26.5K | 48.6K | 1.83 |
| Guide-10 | 27.8K | 48.1K | 1.73 |
| Guide-11 | 27.9K | 50.0K | 1.79 |
| Guide-12 | 27.2 | 48.7 | 1.79 |
| Guide-13 | 28.1 | 47.8 | 1.70 |
| Average | 27.6 | 49.3 | 1.78 |
| Standard Deviation | 0.8 | 1.3 | 0.05 |

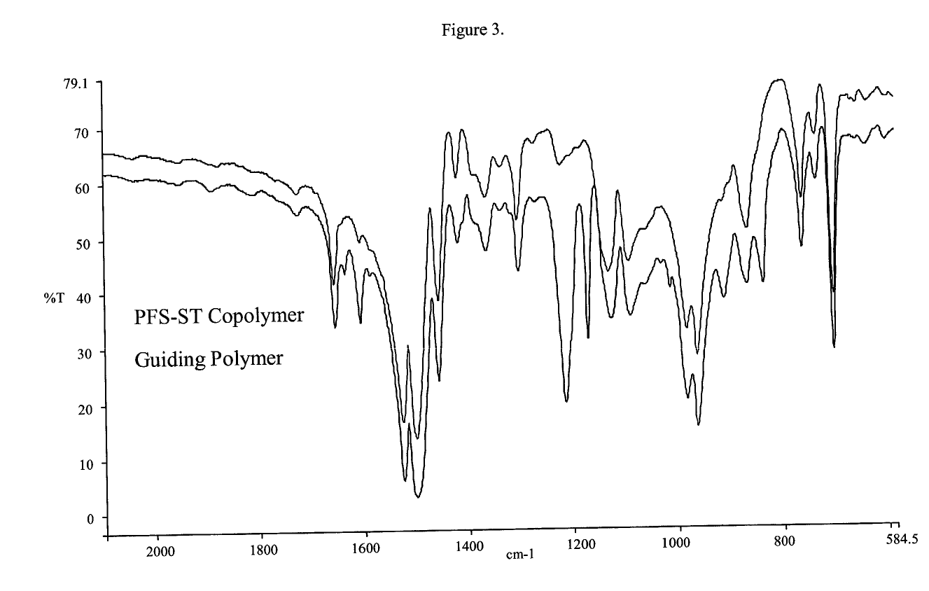

FTIR spectra were obtained for the base copolymer prepared in Example 1 and the guiding polymer prepared above. The spectra are provided in FIG. 3. FTIR-mid was used to determine the ratios of ST to PFS in the guiding polymer prepared as described above. The ratios of characteristic peaks for ST and PFS (at 703 cm⁻¹ and 1654 cm⁻¹, respectively) may be compared to determine the consistency of the synthesis. The results of the analysis are provided in Table 6.

TABLE 6

Height

| | Sty | PFS | Ratios |
|---|---|---|---|
| | 703 cm⁻¹ | 1654 cm⁻¹ | Sty/PFS |
| Guide-1 | 0.741 | 0.329 | 2.26 |
| Guide-2 | 0.282 | 0.116 | 2.42 |
| Guide-3 | 0.792 | 0.361 | 2.19 |
| Guide-4 | 0.377 | 0.166 | 2.28 |
| Guide-5 | 0.338 | 0.161 | 2.10 |
| Guide-6 | 0.287 | 0.130 | 2.22 |
| Guide-7 | 0.343 | 0.161 | 2.13 |
| Guide-8 | 0.607 | 0.267 | 2.28 |
| Guide-9 | 0.212 | 0.094 | 2.25 |
| Guide-10 | 0.420 | 0.188 | 2.24 |
| Guide-11 | 0.683 | 0.291 | 2.34 |
| Guide-12 | 0.533 | 0.253 | 2.11 |
| Guide-13 | 0.225 | 0.095 | 2.38 |
| Guide-14 | 0.483 | 0.213 | 2.27 |
| Guide-15 | 0.407 | 0.178 | 2.29 |
| Average | | | 2.24 |
| Standard Deviation | | | 0.09 |

FTIR-mid was used to determine the ratios of vinyl (e.g., of the styrenic crosslinking group) to ST to PFS in the guiding polymer prepared as described above. The ratios of characteristic peaks for vinyl, ST, and PFS (at 1212 cm⁻¹, 703 cm⁻¹ and 1654 cm⁻¹, respectively) may be compared to determine the consistency of the synthesis. The results of the analysis are provided in Table 7.

TABLE 7

| | Height | | | | |
|---|---|---|---|---|---|
| | vinyl | Sty | PFS | Ratios | |
| | 1212 cm⁻¹ | 703 cm⁻¹ | 1654 cm⁻¹ | vinyl/PFS | Sty/PFS |
| Guide-1 | 0.216 | 0.162 | 0.085 | 2.548 | 1.904 |
| Guide-2 | 0.183 | 0.148 | 0.068 | 2.692 | 2.182 |
| Guide-3 | 0.337 | 0.285 | 0.136 | 2.487 | 2.105 |
| Guide-4 | 0.390 | 0.322 | 0.155 | 2.515 | 2.079 |
| Guide-5 | 0.143 | 0.121 | 0.055 | 2.593 | 2.191 |
| Guide-6 | 0.449 | 0.373 | 0.178 | 2.528 | 2.100 |
| Guide-7 | 0.457 | 0.401 | 0.185 | 2.470 | 2.170 |
| Guide-8 | 0.279 | 0.220 | 0.104 | 2.694 | 2.126 |
| Guide-9 | 0.263 | 0.202 | 0.100 | 2.620 | 2.014 |
| Guide-10 | 0.614 | 0.506 | 0.238 | 2.581 | 2.125 |
| Guide-11 | 0.712 | 0.653 | 0.295 | 2.418 | 2.217 |
| Guide-12 | 1.016 | 0.781 | 0.417 | 2.435 | 1.870 |
| Guide-13 | 0.851 | 0.707 | 0.353 | 2.411 | 2.001 |
| Guide-14 | 0.384 | 0.311 | 0.157 | 2.451 | 1.986 |
| Guide-15 | 0.390 | 0.300 | 0.143 | 2.722 | 2.094 |
| Guide-16 | 0.346 | 0.261 | 0.124 | 2.796 | 2.107 |
| Guide-17 | 0.333 | 0.262 | 0.120 | 2.776 | 2.184 |
| Guide-18 | 0.522 | 0.408 | 0.199 | 2.621 | 2.046 |
| Guide-19 | 0.508 | 0.388 | 0.182 | 2.796 | 2.132 |
| Guide-20 | 0.459 | 0.366 | 0.175 | 2.623 | 2.09 |
| Average | | | | 2.610 | 2.075 |
| Standard | | | | 0.15 | 0.10 |
| Deviation | | | | | |

Purities of samples of the polymer prepared as described above were analyzed by dry weight (30 minute isotherm at 150° C.). The results of the analysis are provided in Table 8.

TABLE 8

| Sample | Purity |
|---|---|
| Guide-1 | 99.6802 |
| Guide-2 | 99.4546 |
| Guide-3 | 99.4546 |
| Guide-4 | 99.8609 |
| Guide-5 | 99.8164 |
| Guide-6 | 99.8701 |
| Guide-7 | 99.8779 |
| Guide-8 | 99.8451 |
| Guide-9 | 99.8857 |
| Guide-10 | 99.8592 |
| Guide-11 | 99.3090 |
| Guide-12 | 99.2298 |

Preparation of Polymer Solution

40 g of the polymer prepared as described above and 1.60 g RH and 0.40 g CTX were dissolved with stirring in 60 g cyclopentanone. After the polymer and the photoinitiator were completely dissolved, the solution was allowed to stand overnight (approximately 16 to 20 hours). The solution was filtered twice with either a polytetrafluoroethylene or nylon 0.20 μm filter, after which the solution was allowed to stand for another 24 hours. The resulting solution had a viscosity of approximately 190-200 cP at 21° C., and a polymer concentration of 32 wt. %.

Viscosity, nD, and density of solutions of guiding polymers prepared as described above, but with a polymer concentration of 40 wt %, were determined. The results of the analysis are provided in Table 9.

TABLE 9

| Solution | Viscosity (cP) | nD | Density (g/cm³) |
|---|---|---|---|
| Guide-1 | 183.0 | 1.4688 | 1.1067 |
| Guide-2 | 190.3 | 1.4690 | 1.1076 |
| Guide-3 | 195.0 | 1.4690 | 1.1119 |
| Guide-4 | 199.8 | 1.4691 | 1.1100 |
| Guide-5 | 198.2 | 1.4699 | 1.1066 |

### EXAMPLE 4

### Preparation and Characterization of a Cladding Layer Polymer

A polymer having styrenic moieties as the crosslinking groups was prepared using as starting materials the PFS-ST base copolymer of Example 1 and the 4-hydroxystyrene of Example 2. The mole ratio PFS:ST of the base copolymer was 80:20. The quantities of reagents for the reactions were calculated as follows. The mean molecular weight of the base copolymer having the above monomer ratio was calculated according to the following equation:

(Mmol_{PFS}*0.8)+(0.2*Mmol_{styrene})=\overline{M}molar

(194.10 g/mol*0.8)+(0.2*104.15 g/mol)=176.11 g/mol

The quantity (in moles) of base copolymer to prepare a given amount of functionalized copolymer was calculated according to the following equations:

$$\begin{matrix}( \frac{{m}_{co \text{-} PFS \text{/} Styrene}}{\overline{{M}_{molaire}}} ) mol \cdot of \cdot co \text{-} PFS \text{/} Styrene \\ ( \frac{30.00 g}{176.11 g \text{/} mol} ) = 0.1703 mol\end{matrix}$$

The quantity (in grams) of 4-hydroxystyrene to functionalize 10% of the PFS monomers was calculated according to the following equations:

(Nbmol_{Co-PFS/Styrene}*20%)*Mmol_{parahydroxystyrene}=M_{parahydroxystyrene}

[(0.1703*10%)÷90%]*120.15 g/mol=2.270 g

The quantity (in grams) of NaH for the functionalization reaction was calculated according to the following equation:

Nbmol_{parahydroxystyrene}*1.02*Mmol_{sodiumhydrid}=M_{sodiumhydride}

0.0189 mol*1.02*24.00 g/mol=0.465 g

The quantity (in ml) of DMAc for the functionalization reaction was calculated according to the following equations:

M_{polymer}×10=V_{DMAc}

30 g×10=300 ml.

Polymer Preparation

A 500-ml three-neck flask was flame dried and equipped with a stirring bar and a Dean-Stark trap. The flask and Dean-Stark trap were cooled with nitrogen streams and all openings were immediately closed with septums. The Dean-Stark trap was connected to the three-neck flask, which was then installed in an oil bath. A clean 30 cm needle was flame dried and cooled with a nitrogen stream, then set at the end of a syringe containing a dessicant (Drierite). A needle connected to a hose of a bubble gauge was then inserted in the septum used to close the Dean-Stark trap, and nitrogen was allowed to gently flow into the setup. The amount of injected nitrogen was controlled with the bubble gauge.

2.270 g of 4-hydroxystyrene prepared as in Example 2 was added to the three-neck flask. A 30-cm stainless-steel needle was flame dried, cooled with a nitrogen stream, and inserted into the end of a 60-ml syringe and used to add 60 ml of anhydrous dimethylacetamide (DMAc) (Aldrich, 98.9% purity) to the flask. An additional 60 ml of DMAc was then injected, and stirring of the solution was initiated. The injection procedure was repeated until a total of 300 ml of DMAc was injected.

The interior of the neck through which the DMAc has been injected was wiped clean and the neck immediately closed. 30 g of base copolymer prepared in Example 1 was added to the three-neck flask. The polymer was allowed to solubilize completely over 30-40 minutes. 0.232 g of NaH was added to the reaction solution. The reaction was allowed to proceed for approximately 20 minutes, after which additional NaH was added such that the total weight of NaH was 465 mg. The reaction was allowed to proceed for approximately an hour. The temperature of the reaction to was increased from 20° C. to 106° C. over the course of an hour, then the reaction was allowed to proceed for another 2.5 hours. The solution was then cooled to 40° C. 2.5 ml iodomethane (Spectrum, 99.5% purity) was added to the solution, and the reaction was permitted to proceed for 30 minutes.

3 liters of methanol and a magnetic stirring bar were added to a 4-liter beaker, followed by 15 ml of acetic acid, after which stirring of the mixture commenced. The reaction mixture was poured from the three-neck flask into an addition funnel suspended over the 4-liter beaker, and then the funnel valve was opened to permit the reaction solution to flow into the beaker. The resulting precipitated polymer was filtered through a fritted glass filter, then washed twice with 75 ml of methanol per wash. After drying the polymer on the filter, it was stored in a petri dish covered with perforated aluminum and allowed to air dry overnight until a mass of ≦50 gram was achieved. If after drying overnight the mass is still >50 g, then the polymer is placed in a vacuum oven until the mass is ≦50 g.

The polymer was then purified in a first purification step. The polymer was added to a 500-ml beaker along with a magnetic stirring bar. 280 ml of toluene was then added, and the mixture was stirred until the polymer was fully dissolved. The solution was allowed to stand without stirring for approximately 2 hours, after which the resulting polymer solution was filtered with a vacuum filtering setup comprising a 500-ml vacuum Erlenmeyer, a Buchner funnel, and a paper filter (qualitative 410). The Buchner funnel was filled with Celite to within 1 cm of its top. The mixture of polymer in toluene was poured over the Celite. 200 ml of a clear, light yellow polymer solution was obtained.

A 2-liter beaker filled with methanol, 10 ml of acetic acid, and a magnetic stirring bar. Stirring was initiated, and the polymer solution was poured into the 2-liter beaker, resulting in precipitation of the polymer. The polymer was vacuum-filtered with a fritted glass filter, washed twice with 75 ml of methanol per washing, and allowed to dry on the filter.

The resulting polymer powder was placed in a petri dish covered with perforated aluminum foil and allowed to stand overnight. The polymer was weighed. If the mass was greater than 50 grams, the polymer was placed in a vacuum oven at room temperature to further dry the polymer until the mass was ≦50 grams.

The polymer was then purified in a second purification step. The polymer was added to a 500-ml beaker along with a magnetic stirring bar. 280 ml of toluene was then added, and the mixture was stirred until the polymer was fully dissolved. The solution was allowed to stand for approximately 2 hours, after which the resulting polymer solution was filtered with a vacuum filtering setup as described in the first purification step to yield 200 ml of a clear, light yellow polymer solution. The solution was further filtered with a 0.2 μm filter.

A 2-liter beaker was filled with methanol, 10 ml of acetic acid, and a magnetic stirring bar. Stirring was initiated, and the polymer solution was poured into the 2-liter beaker, resulting in precipitation of the polymer. The solution was allowed to stand for approximately 2 hours, after which the resulting mixture was filtered using a vacuum filtering setup comprising a vacuum Erlenmeyer flask and Buchner funnel into which a paper filter (qualitative 410) was placed. The polymer was washed twice with 50 ml of methanol per washing, and allowed to dry on the filter.

The resulting polymer powder was placed in a petri dish covered with perforated aluminum foil and allowed to stand overnight. The polymer was then dried in a vacuum oven at room temperature for 5 days.

Samples of cladding copolymer prepared as described above were characterized using differential scanning calorimetry (DSC) and thermogravimetric analysis (TGA). The results of the analysis are provided in Table 10.

TABLE 10

| | Tg (° C.) | Tg (° C.) | |
|---|---|---|---|
| Sample Number | linear | crosslinked | T_{dec.} (° C.) |
| Cladding-1 | 101 | — | 430 |

GPC was used to determine molecular number (Mn), molecular weight (Mw), and polydispersity (PD) for samples of cladding polymers having various monomer ratios prepared as described above. Purity was determined using TGA with a 30 minute isotherm at 150° C. The results of the analysis are provided in Table 11.

TABLE 11

| Sample Number | Ratio ether/PFS | Ratio Sty/PFS | Mn | Mw | PD | Purity |
|---|---|---|---|---|---|---|
| Cladding-1 | 1.27 | 1.96 | 25008 | 43491 | 1.74 | 99.69 |
| Cladding-2 | 1.32 | 2.00 | 25361 | 44140 | 1.74 | 99.81 |
| Cladding-3 | 1.40 | 2.03 | 26352 | 46023 | 1.75 | — |
| Cladding-4 | 1.40 | 2.03 | 26352 | 46023 | 1.75 | 99.69 |
| Cladding-5 | 1.50 | 2.07 | 25664 | 45051 | 1.76 | 99.96 |
| Cladding-6 | 1.55 | 2.17 | 25561 | 42229 | 1.65 | — |

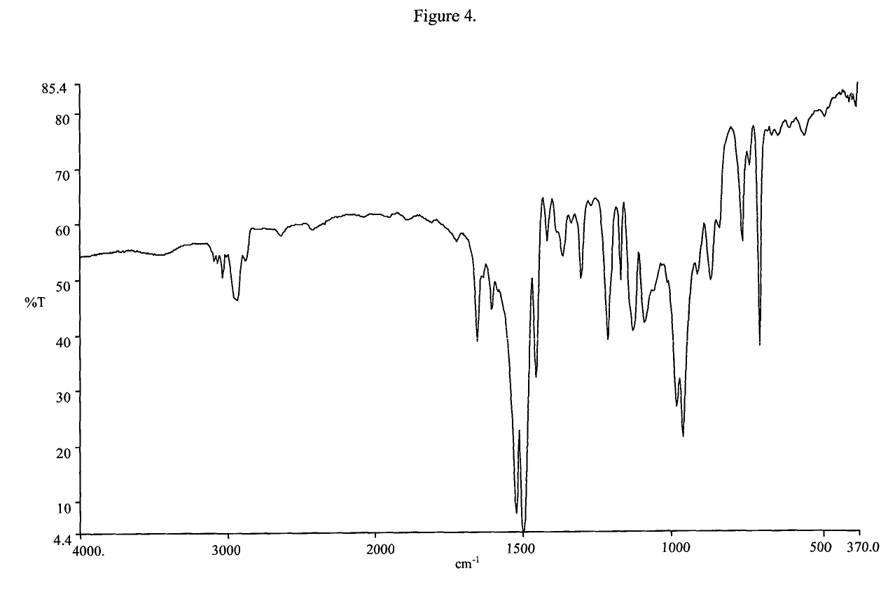

An FTIR spectrum was obtained for the cladding polymer prepared above. The spectrum is provided in FIG. 4.

Preparation of Polymer Solution

24 g of the polymer prepared as described above was dissolved with stirring in 44.5 g cyclopentanone. After the polymer was completely dissolved, 0.5854 g recrystallized BPO (Anachemia, >70% purity before recrystallization) was added to the solution. The solution was stirred until the BPO was completely dissolved, then filtered with a 0.20 μm filter under a vacuum pressure of 60 psi. The filter was replaced after one half of the solution was filtered. The solution was allowed to stand overnight (approximately 16 to 20 hours). The resulting solution had a viscosity of approximately 100 cP at 21° C., and a polymer concentration of 35 wt. %.

Viscosity, nD, and density of solutions of cladding polymers prepared as described above were determined. The results of the analysis are provided in Table 12.

TABLE 12

| Solution | Viscosity (cP) | nD | Density (g/cm³) |
|---|---|---|---|
| Cladding-1 | 98.5 | 1.4611 | 1.0936 |
| Cladding-2 | 79.6 | 1.4605 | 1.0878 |
| Cladding-3 | 99.6 | 1.4610 | 1.0936 |
| Cladding-4 | 86.6 | 1.4602 | 1.0901 |

### EXAMPLE 5

### Preparation and Characterization of a Buffer Layer Polymer

A buffer layer polymer comprising 2,3,4,5,6-pentafluorostyrene, styrene, and glycidyl methacrylate (GMA) was prepared. A mole ratio of ST:PFS:GMA of 15:55:30 was selected for the buffer polymer.

When a scale-up (or scale-down) of the polymerization reaction is performed, it may be necessary to adjust the quantities of raw materials to obtain the desired molecular weight. The ratios between the required raw materials may not always be linear.

The materials were purified prior to use in the reactions. PFS, GMA, and ST were each injected individually into a purification column containing an appropriate “inhibitor remover” (Aldrich Cat. No. 31,133-2, HQ/MEHQ for PFS and GMA, and Aldrich Cat. No. 31,134-0, tert-butylcatechol for ST). The purity of the reagents was determined by Gas Chromatography-Mass Spectrometry (GC-MS).

Benzoyl peroxide (BPO) was purified by recrystallization as described in Example 1.

The polymerization reaction was conducted as follows. First, a 1000-ml three-neck flask was flame-dried and cooled with nitrogen. Under a fume hood, 100 g of PFS (Aldrich, >99% purity prior to purification), 14.63 g ST (Spectrum, >99% purity prior to purification), and 54.58 g GMA (Aldrich, >97% purity prior to purification) were weighed into the flask. 1.95 g of recrystallized BPO (Anachemia, >70%purity before recrystallization) were weighed out and added to the contents of the flask. 330 ml of toluene was added to the flask. The walls of the flask were rinsed while adding the toluene to the flask. The solution in the flask was stirred under a continuous stream of nitrogen flow to fully dissolve the BPO. Once the BPO was fully dissolved, the heating process was initiated by raising the temperature of the solution gradually over a 1 hour period from room temperature to 70±1° C. The polymerization reaction was then allowed to proceed for 20 hours. The heat was then removed and the solution cooled to room temperature. The solution viscosity was adjusted to 10.4 cP at room temperature (˜20° C.) by adding toluene (approximately 290 ml).

Next, the base copolymer was precipitated. The amount of methanol to initiate precipitation of the polymer was calculated according to the following equation:

Vol. Methanol=10.4×Vol. Toluene

The methanol was added to a beaker equipped with a stirring bar, along with a volume of glacial acetic acid corresponding to 0.5% of the total volume of methanol added. The polymer solution was added dropwise to the methanol. A white polymer precipitated during slow addition of methanol with stirring at room temperature. The polymer was collected by vacuum filtration with a fritted glass filter. The precipitated polymer was washed three times with methanol. The polymer was allowed to air dry for about 16 hours, then was further dried in an oven at 40° C. for 24 hours.

The yield of the polymer was approximately 95 g. The resulting polymer was stored in a flame-dried hermetic tinted jar kept in a dessicator.

GPC was used to determine molecular number (Mn), molecular weight (Mw), and polydispersity (PD) for samples of buffer polymers prepared as described above. The results of the analysis are provided in Table 13.

TABLE 13

| Sample | Mn | Mw | PD |
|---|---|---|---|
| Buffer-1 | 36947 | 71757 | 1.94 |
| Buffer-2 | 34825 | 64947 | 1.86 |
| Buffer-3 | 36985 | 74193 | 2.01 |
| Buffer-4 | 35100 | 65500 | 1.86 |
| Buffer-5 | 36508 | 65404 | 1.79 |
| Buffer-6 | 34966 | 62045 | 1.77 |
| Buffer-7 | 34694 | 62045 | 1.76 |
| Buffer-8 | 43747 | 137228 | 3.14 |
| Buffer-9 | 41150 | 77577 | 1.89 |
| Buffer-10 | 45123 | 90131 | 2.00 |
| Buffer-11 | 33124 | 57242 | 1.73 |
| Buffer-12 | 39902 | 73964 | 1.85 |
| Buffer-13 | 41532 | 77711 | 1.87 |
| Buffer-14 | 26751 | 53210 | 1.99 |
| Buffer-15 | 32628 | 58493 | 1.79 |
| Buffer-16 | 32066 | 58289 | 1.82 |
| Buffer-17 | 32036 | 59821 | 1.87 |
| Buffer-18 | 34572 | 69248 | 2.00 |
| Buffer-19 | 31849 | 58996 | 1.85 |
| Buffer-20 | 30451 | 57517 | 1.89 |
| Buffer-21 | 34205 | 77941 | 2.28 |
| Buffer-22 | 35307 | 71578 | 2.03 |
| Average | 36153 | 67501 | 1.86 |
| Standard Deviation | 4496 | 9901 | 0.09 |

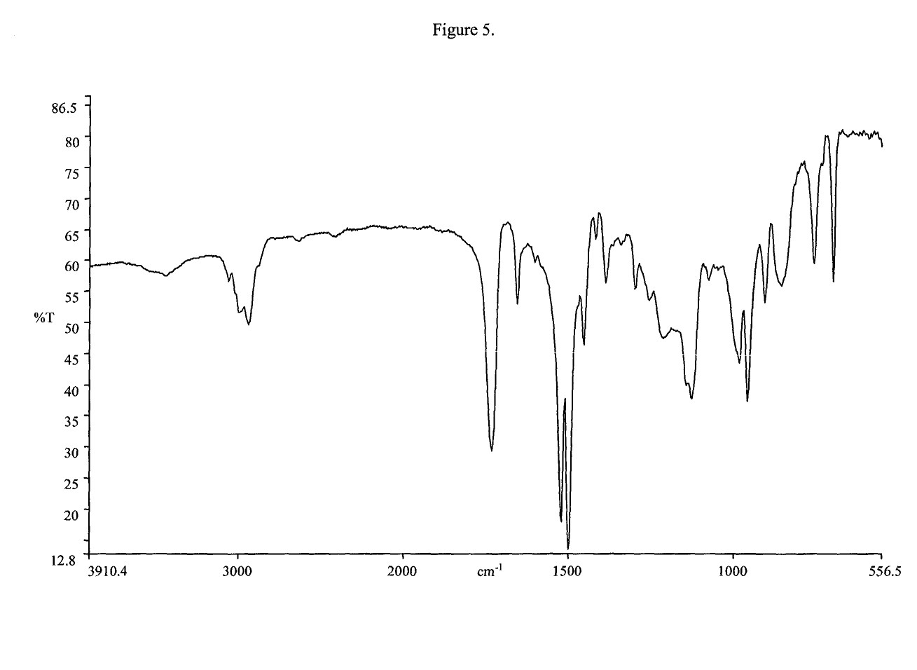

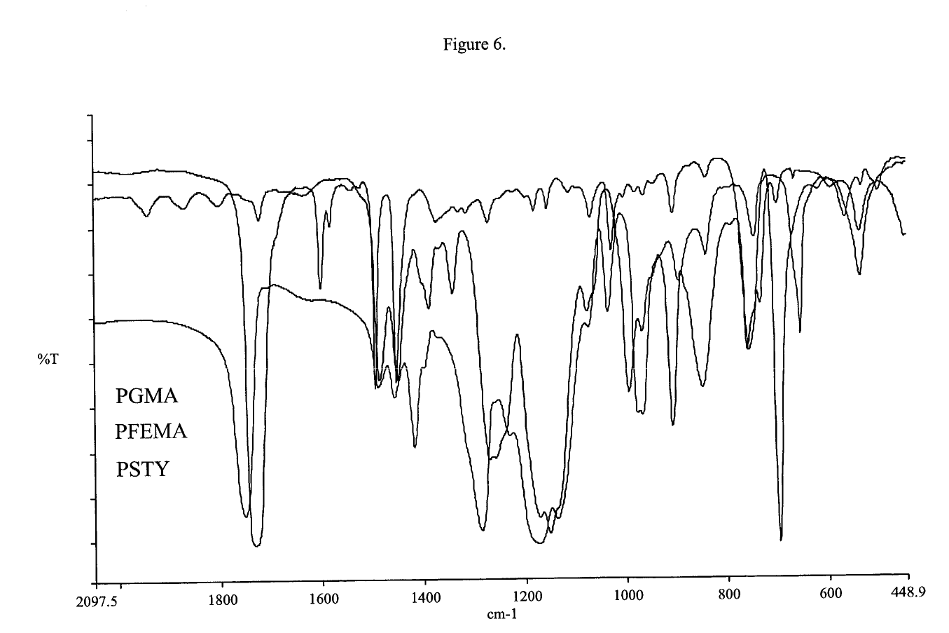

An FTIR spectrum was obtained for the buffer polymer prepared above. The spectrum is provided in FIG. 5. FTIR spectra were obtained for homopolymers of ST, FEMA (trifluoroethylmethacrylate), and GMA for comparison purposes. These spectra are provided in FIG. 6. FTIR-mid was used to determine the ratios of GMA to ST to PFS in the buffer polymer prepared as described above. The ratios of characteristic peaks for GMA, ST, and PFS (at 1734 cm⁻¹, 703 cm⁻¹ and 1654 cm⁻¹, respectively) may be compared to determine the consistency of the synthesis. The results of the analysis are provided in Table 14.

TABLE 14

| | Height | | | | |
|---|---|---|---|---|---|
| | GMA | Sty | PFS | Ratios | |
| | 1734 cm⁻¹ | 703 cm⁻¹ | 1654 cm⁻¹ | GMA/PFS | Sty/PFS |
| Buffer-1 | 0.170 | 0.111 | 0.054 | 3.156 | 2.066 |
| Buffer-2 | 0.370 | 0.277 | 0.131 | 2.820 | 2.111 |
| Buffer-3 | 0.292 | 0.178 | 0.089 | 3.297 | 2.005 |
| Buffer-4 | 0.325 | 0.197 | 0.101 | 3.232 | 1.962 |
| Buffer-5 | 0.219 | 0.134 | 0.066 | 3.308 | 2.018 |
| Buffer-6 | 0.409 | 0.225 | 0.113 | 3.63 1 | 2.000 |
| Buffer-7 | 0.139 | 0.088 | 0.041 | 3.361 | 2.118 |
| Buffer-8 | 0.383 | 0.280 | 0.129 | 2.969 | 2.169 |
| Buffer-9 | 0.189 | 0.123 | 0.061 | 3.098 | 2.024 |
| Buffer-10 | 0.274 | 0.182 | 0.088 | 3.120 | 2.073 |
| Buffer-11 | 0.5886 | 0.3074 | 0.155 | 3.797 | 1.983 |
| Buffer-12 | 0.2764 | 0.1612 | 0.0819 | 3.375 | 1.968 |
| Buffer-13 | 0.3324 | 0.1666 | 0.0829 | 4.010 | 2.010 |
| Buffer-14 | 0.4404 | 0.1998 | 0.1106 | 3.982 | 1.807 |
| Buffer-15 | 0.3458 | 0.1713 | 0.0872 | 3.966 | 1.964 |
| Buffer-16 | 0.2401 | 0.1079 | 0.0579 | 4.147 | 1.864 |
| Average | 0.3612 | 0.2012 | 0.1006 | 3.487 | 1.998 |
| Standard | | | | 0.405 | 0.083 |
| Deviation | | | | | |

Purities of samples of the polymer prepared as described above were analyzed by dry weight (30 minute isotherm at 150° C.). The results of the analysis are provided in Table 15.

TABLE 15

| Sample | Purity |
|---|---|
| Buffer-1 | 99.65% |
| Buffer-2 | 99.65% |
| Buffer-3 | 99.42% |
| Buffer-4 | 98.63% |
| Buffer-5 | 99.64% |
| Buffer-6 | 99.73% |
| Buffer-7 | 99.71% |
| Buffer-8 | 99.57% |
| Buffer-9 | 99.55% |

Preparation of Polymer Solution

45 g of the polymer prepared as described above was dissolved with stirring in 44 g cyclopentanone and 11 g γ-butyrolactone. After the polymer was completely dissolved, 2.30 g recrystallized DBU (Spectrum, >98% purity before recrystallization) was added to the solution. The solution was stirred until the DBU was completely dissolved, then filtered with a 0.20 μm filter under a vacuum pressure of 60 psi. The filter was replaced after one half of the solution was filtered. The solution was allowed to stand overnight (approximately 16 to 20 hours). The resulting solution had a viscosity of approximately 1600-2000 cP at 21° C., and a polymer concentration of 45 wt. %. Prior to use, the polymer solution placed in an amber jar pre-dried using a flame and maintained under refrigeration at a temperature of 0-5° C.

Viscosity, nD, and density of solutions of buffer polymers prepared as described above were determined. The results of the analysis are provided in Table 16.

TABLE 16

| Solution | Viscosity (cP) | nD | Density (g/cm³) |
|---|---|---|---|
| Buffer-1 | 2017.0 | 1.4666 | 1.1446 |
| Buffer-2 | 1635.0 | 1.4666 | 1.1432 |
| Buffer-3 | 1429 | 1.4666 | 1.1424 |

### EXAMPLE 6

### Microfabrication Results

An optical device was fabricated from polymeric materials including the polymer of Example 5 as the buffer and cladding layers and the polymer of Example 3 as the guide layer. A 0.22 μm thick anti-reflective coating was applied directly to a SiO₂ silicon wafer (6 inches in diameter) by spin coating 3 ml of the coating material onto the wafer over 60 seconds at a final spin speed of 2000 rpm. The coating material used was XHRiC-16 (Brewer Science, Inc. of Rolla, Mo.). The anti-reflective coating was 0.22 μm thick.

A buffer layer solution was then prepared from POLYMER #1, and spin-coated onto a substrate. The buffer layer solution included 45 wt. % solids, and was prepared using cyclopentanone as the solvent. The viscosity of the buffer layer solution was 2000 cP. A 15 μm thick buffer layer was applied over the anti-reflective coating by spin coating 7 ml of the coating material onto the wafer over 60 seconds at a final spin speed of 2000 rpm. The substrate was set on a hotplate at 130° C. for 180 seconds in ambient atmosphere. The buffer layer was subsequently hard-baked in a nitrogen atmosphere. The temperature of the substrate was raised from 0° C. to 200° C. over 60 minutes, then the temperature was held at 200° C. for 120 minutes.

Next, a guiding layer solution was prepared from POLYMER #2. The guiding layer solution included 4% RH and 1% CTX as crosslinking initiators. A 6.5 μm thick guiding layer was applied over the buffer layer by spin coating 5 ml of the coating material onto the wafer over 60 seconds at a final spin speed of 2000 rpm. A pre-bake was conducted at a temperature of 60° C. for 30 seconds in ambient atmosphere. The guiding layer was subsequently pattered by exposure to UV radiation at a dose of 600 mJ/cm². The buffer layer was then subjected to a post-exposure bake at a temperature of 120° C. for 30 seconds. After the post-bake, the guiding layer was wet-etched using acetone for 60 seconds. A heating step at 170° C. for 60 seconds on a hot plate was then conducted, followed by a hard bake at 140° C. for 120 minutes, and then the hard-bake was completed by reducing the temperature from 140° C. down to 20° C. for 60 minutes. The hard-bake was conducted under vacuum.

Finally, a cladding layer solution was prepared. The cladding layer solution was identical to the buffer layer solution. A 10 μm thick buffer layer was applied over the guiding layer by spin coating 10 ml of the coating material onto the wafer over 60 seconds at a final spin speed of 300 rpm. The substrate was set on a hotplate at 130° C. for 180 seconds under vacuum. The buffer layer was subsequently hard-baked in a nitrogen atmosphere. The temperature of the substrate was raised from 0° C. to 140° C. over 30 minutes, then the temperature was held at 140° C. for 120 minutes.

Optical and physical characterization of the resulting layers indicated that the buffer layer had a refractive index of 1.4900, the guiding layer had a refractive index of 1.4990, and the cladding layer had a refractive index of 1.4900 (Δn=0.009). The average thickness of the buffer layer was 15430 nm (roughness (Rq)=0.67 nm), with a standard deviation of 93 nm (Rq=0.06 nm). The average linewidth of the guide was 6100 nm and the average thickness was 6400 nm (Rq=0.9), with a standard deviation for the linewidth of 100 nm and for the thickness of 85 nm (Rq=0.5). The average thickness of the cladding layer was 10 μm, with a standard deviation of 0.3 μm.

### EXAMPLE 7

### Glass Transition Temperatures

Tg's of a representative a cured guide polymer as prepared according to Example 3, a cured cladding polymer as prepared according to Example 4, and a cured buffer polymer as prepared according to Example 5, as measured by thermomechanical analysis (TMA), are provided in Table 18.

TABLE 18

| Sample | Tg onset (° C.) | Tg (° C.) |
|---|---|---|
| buffer polymer | 106.4 | 116.6 |
| guide polymer | 146.5 | 153.5 |
| cladding polymer | 114.5 | 120.5 |

The above description provides several methods and materials of the present invention. This invention is susceptible to modifications in the methods and materials, as well as alterations in the fabrication methods and equipment. Such modifications will become apparent to those skilled in the art from a consideration of this disclosure or practice of the invention disclosed herein. Consequently, it is not intended that this invention be limited to the specific embodiments disclosed herein, but that it cover all modifications and alternatives coming within the true scope and spirit of the invention as embodied in the attached claims.

Every patent and other reference mentioned herein is hereby incorporated by reference in its entirety.

What is claimed is:

1. A polymeric material, the material comprising a glycidyl methacrylate monomer; a 2,3,4,5,6-pentafluorostyrene monomer; and a styrene monomer.

2. The polymeric material of claim 2, wherein a weight ratio of glycidyl methacrylate monomer to 2,3,4,5,6-pentafluorostyrene monomer to styrene monomer is about 5 to about 30:about 30 to about 90:about 5 to about 40.

3. The polymeric material of claim 2, wherein a weight ratio of glycidyl methacrylate monomer to 2,3,4,5,6-pentafluorostyrene monomer to styrene monomer is about 10 to about 25:about 40 to about 80:about 10 to about 35.

4. The polymeric material of claim 2, wherein a weight ratio of glycidyl methacrylate monomer to 2,3,4,5,6-pentafluorostyrene monomer to styrene monomer is about 15 to about 20:about 50 to about 70:about 15 to about 30.

5. An optical device comprising a polymeric material formed from a glycidyl methacrylate monomer; a 2,3,4,5,6-pentafluorostyrene monomer; and a styrene monomer.

6. The optical device of claim 5, wherein the optical device is an integrated optical waveguide device.

7. The optical device of claim 5, wherein the optical device is a dense wavelength division multiplexing device.

8. The optical device of claim 5, wherein the optical device comprises a substrate, a buffer layer, a guide layer, and a cladding layer.

9. The optical device of claim 5, wherein the buffer layer comprises the polymeric material formed from glycidyl methacrylate monomer; 2,3,4,5,6-pentafluorostyrene monomer; and styrene monomer.

10. A process for preparing a pojymeric material for use in fabricating an optical device, the process comprising the steps of:
providing a first monomer comprising glycidyl methacrylate;
providing a second monomer comprising styrene;
providing a third monomer comprising 2,3,4,5,6-pentafluorostyrene;
providing a polymerization catalyst; and
polymerizing the monomers, whereby a terpolymeric material suitable for use in fabricating an optical device is obtained.

11. The process of claim 10, wherein the polymerization catalyst comprises benzoyl peroxide.

12. A polymeric material, the material comprising a styrene monomer, a 2,3,4,5,6-pentafluorostyrene monomer, and a 2,3,5,6-pentafluoro-4-oxystyrene-styrene monomer.

13. The polymeric material of claim 12, wherein a weight ratio of styrene monomer to 2,3,4,5,6-pentafluorostyrene monomer to 2,3,5,6-pentafluoro-4-oxystyrene-styrene monomer is about 5 to about 30:about 30 to about 90:about 10 to about 35.

14. The polymeric material of claim 12, wherein a weight ratio of styrene monomer to 2,3,4,5,6-pentafluorostyrene monomer to 2,3,5,6-pentafluoro-4-oxystyrene-styrene monomer is about 10 to about 25:about 50 to about 80:about 10 to about 30.

15. The polymeric material of claim 12, wherein a weight ratio of styrene monomer to 2,3,4,5,6-pentafluorostyrene monomer to 2,3,5,6-pentafluoro-4-oxystyrene-styrene monomer is about 15 to about 25:about 55 to about 70:about 15 to about 25.

16. The polymeric material of claim 12, wherein a weight ratio of styrene monomer to 2,3,4,5,6-pentafluorostyrene monomer to 2,3,5,6-pentafluoro-4-oxystyrene-styrene monomer is about 5 to about 30:about 40 to about 90:about 5 to about 25.

17. The polymeric material of claim 12, wherein a weight ratio of styrene monomer to 2,3,4,5,6-pentafluorostyrene monomer to 2,3,5,6-pentafluoro-4-oxystyrene-styrene monomer is about 10 to about 25:about 50 to about 80:about 8 to about 20.

18. The polymeric material of claim 12, wherein a weight ratio of styrene monomer to 2,3,4,5,6-pentafluorostyrene monomer to 2,3,5,6-pentafluoro-4-oxystyrene-styrene monomer is about 15 to about 25:about 55 to about 70:about 10 to about 15.

19. The polymeric material of claim 12, wherein a weight ratio of styrene monomer to 2,3,4,5,6-pentafluorostyrene monomer to 2,3,5,6-pentafluoro-4-oxystyrene-styrene monomer is about 0.2:about 0.6:about 0.2.

20. An optical de vice comprising a polymeric material formed from a styrene monomer, a 2,3,4,5,6-pentafluorostyrene monomer, and a 2,3,5,6-pentafluoro-4-oxystyrene-styrene monomer.

21. The optical device of claim 20, wherein the optical device is an integrated optical waveguide device.

22. The optical device of claim 20, wherein the optical device is a dense wavelength division multiplexing device.

23. The optical device of claim 20, wherein the optical device comprises a substrate, a buffer layer, a guide layer, and a cladding layer.

24. The optical device of claim 20, wherein the guiding layer comprises the polymeric material formed from the styrene monomer, the 2,3,4,5,6-pentafluorostyrene monomer, and the 2,3,5,6-pentafluoro-4-oxystyrene-styrene monomer.

25. The optical device of claim 20, wherein the cladding layer comprises the polymeric material formed from the styrene monomer, the 2,3,4,5,6-pentafluorostyrene monomer, and the 2,3,5,6-pentafluoro-4-oxystyrene-styrene monomer.

26. A process for preparing a polymeric material for use in fabricating an optical device, the process comprising the steps of:
providing a first monomer comprising 2,3,4,5,6-pentafluorostyrene;
providing a second monomer comprising styrene;
providing a polymerization catalyst;
polymerizing the monomers, whereby a copolymeric material is formed, the copolymeric material comprising a plurality of fluorine substituents; and
reacting the copolymeric material with 4-hydroxystyrene in the presence of a base such that a portion of the fluorine substituents are replaced by vinyl phenyl ether substituents, whereby a material suitable for use in fabricating an optical device is obtained.

27. The process of claim 26, wherein the polymerization catalyst comprises benzoyl peroxide.

28. A polymeric material, the material comprising a terpolymer of Formula I: 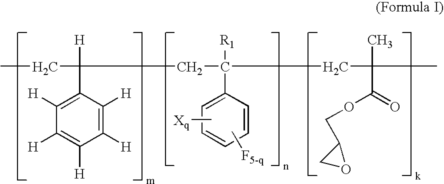
wherein:
q is an integer from 0 to 5;
p is an integer from 0 to 10;
y is an integer from 0 to 4;
R₁ is —CH₃ or H;
X is independently selected from the group consisting of Cl, Br, —CF₃, —(CF₂)ₚ—CF₃, 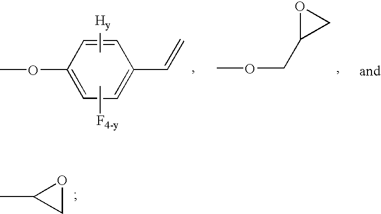
and m, n, and k are non-zero integers.

29. The polymeric material of claim 28, wherein a ratio of m:n:k is about 5 to about 30:about 30 to about 90:about 5 to about 40.

30. The polymeric material of claim 28, wherein a ratio of m:n:k is about 10 to about 25:about 40 to about 80:about 10 to about 35.

31. The polymeric material of claim 28, wherein a ratio of m:n:k is about 15 to about 20:about 50 to about 70:about 15 to about 30.

32. The polymeric material of claim 28, wherein a ratio of m:n:k is about 7:about 2:about 1.

33. The polymeric material of claim 28, wherein X is —C(CF₃)₂H.

34. The polymeric material of claim 28, wherein X is —(CF₂)ₚ—CF₃ and p is 8.

35. The polymeric material of claim 28, wherein X is —(CF₂)ₚ—CF₃ and p is 10.

36. The polymeric material of claim 28, wherein X is 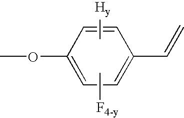
and q is 0.

37. The polymeric material of claim 28, wherein the terpolymer is a block polymer.

38. The polymeric material of claim 28, wherein the terpolymer is a random polymer.

39. An optical device comprising the polymeric material of claim 28.

40. The optical device of claim 39, wherein the optical device is an integrated optical waveguide device.

41. A process for preparing a polymeric material for use in fabricating an optical device, the process comprising the steps of:
a) providing a first monomer comprising glycidyl methacrylate;
b) providing a second monomer of Formula IA 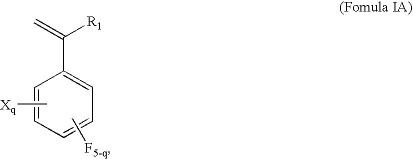
wherein
X is independently selected from the group consisting of Cl, Br, CF₃, —(CF₂)ₚ—CF₃, 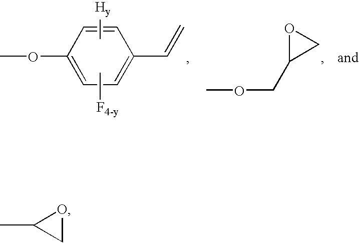
R₁ is —CH₃ or H;
q is an integer from o to 5,
p is an integer from 0 to 10, and
y is an integer from 0 to 4;
c) providing a third monomer of Formula IB 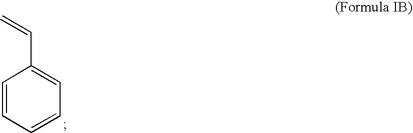
d) providing a polymerization catalyst; and
e) polymerizing the monomers, whereby a polymeric material suitable for use in fabricating an optical device is obtained.

42. A polymeric material, the material comprising a terpolymer of Formula II 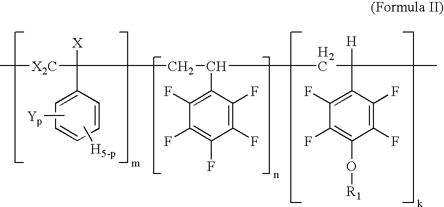
wherein:
X is independently selected from the group consisting of H, D, and F;
Y is independently selected from the group consisting of F and D;
R₁ is 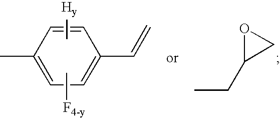
y is an integer from 0 to 4;
p is an integer from 0 to 5; and
m, n, and k are non-zero integers.

43. The polymeric material of claim 42, wherein a ratio of m:n:k is about 5 to about 30:about 40 to about 90:about 5 to about 25.

44. The polymeric material of claim 42, wherein a ratio of m:n:k is about 10 to about 25:about 50 to about 80:about 8 to about 20.

45. The polymeric material of claim 42, wherein a ratio of m:n:k is about 15 to about 25:about 55 to about 70:about 10 to about 15.

46. The polymeric material of claim 42, wherein a ratio of m:n:k is about 5 to about 30:about 40 to about 90:about 10 to about 35.

47. The polymeric material of claim 42, wherein a ratio of m:n:k is about 10 to about 25:about 50 to about 80:about 10 to about 30.

48. The polymeric material of claim 42, wherein a ratio of m:n:k is about 15 to about 25:about 55 to about 70:about 15 to about 25.

49. The polymeric material of claim 42, wherein a ratio of m:n:k is about 0.2:about 0.6:about 0.2.

50. The polymeric material of claim 42, wherein R₁ is

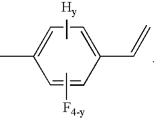

51. The polymeric material of claim 42, wherein R₁ is

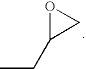

52. The polymeric material of claim 42, wherein X is F.

53. The polymeric material of claim 42, wherein the terpolymer is a block polymer.

54. The polymeric material of claim 42, wherein the terpolymer is a random polymer.

55. An optical device comprising the polymeric material of claim 42.

56. The optical device of claim 55, wherein the optical device is an integrated optical waveguide device.

57. A process for preparing a polymeric material for use in fabricating an optical device, the process comprising the steps of:
a) providing a first monomer comprising 2,3,4,5,6-pentafluorostyrene;
b) providing a second monomer of Formula IIB 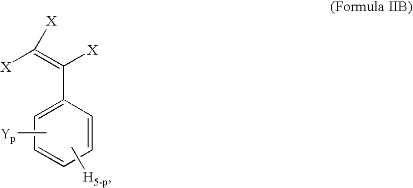
wherein
p is an integer from 0 to 5,
Y is independently selected from the group consisting of F and D, and
X is independently selected from the group consisting of H, D, and F;
c) providing a polymerization catalyst;
d) polymerizing the first monomer and the second monomer, whereby a copolymeric material is obtained, the copolymeric material comprising a plurality of fluorine moieties, the fluorine moieties comprising substituents on a benzene ring; and
e) reacting, under alkaline conditions, the copolymeric material with a hydroxy compound of formula: 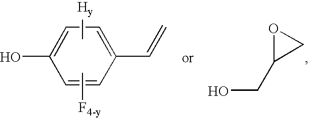
wherein y is an integer from 0 to 4, such that a portion of the fluorine moieties are replaced by an oxy moiety derived from the hydroxy compound, whereby a polymeric material suitable for use in fabricating an optical device is obtained.

58. A polymeric material, the material comprising a terpolymer of Formula III 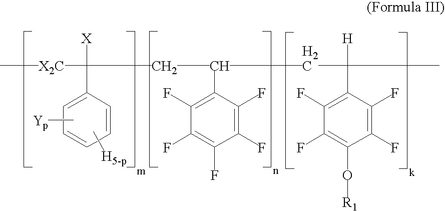
wherein:
X is independently selected from the group consisting of H, D, and F;
Y is independently selected from the group consisting of F and D;
R₁ is 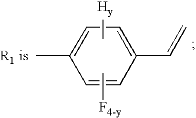
y is an integer from 0 to 4;
p is an integer from 0 to 5; and
m, n, and k are non-zero integers.
